(19) United States
(12) Patent Application Publication
(10) Pub. No.: US 2025/0334771 A1
(43) Pub. Date: Oct. 30, 2025

(54) LENS DRIVING DEVICE, AND CAMERA MODULE AND OPTICAL DEVICE INCLUDING SAME

(71) Applicant: LG INNOTEK CO., LTD., Seoul (KR)

(72) Inventors: Yun Ho NOH, Seoul (KR); Byung Wook SON, Seoul (KR)

(73) Assignee: LG INNOTEK CO., LTD., Seoul (KR)

(21) Appl. No.: 18/855,576

(22) PCT Filed: May 4, 2023
(86) PCT No.: PCT/KR2023/006113

§ 371 Date: Oct. 9, 2024

(30) Foreign Application Priority Data
May 9, 2022 (KR) 10-2022-0056749

(51) Int. Cl. G02B 7/08; G02B 27/64

(52) U.S. Cl. CPC G02B 7/08; G02B 27/646

(57) ABSTRACT

An embodiment includes a housing, a bobbin disposed in the housing and movable in an optical axis direction, an upper elastic member coupled with an upper portion of the bobbin and an upper portion of the housing, a circuit board disposed below the housing, a support member including one end coupled to the upper elastic member and the other end electrically connected to the circuit board, and a first damper coupled to at least a portion of the support member and the housing, wherein the first damper is spaced apart from one end of the support member and is disposed closer to a lower surface of the housing than to an upper surface of the housing.

### CROSS REFERENCE TO RELATED APPLICATIONS

This application is the National Phase of PCT International Application No. PCT/KR2023/006113, filed on May 4, 2023, which claims priority under 35 U.S.C. 119 (a) to Patent Application No. 10-2022-0056749, filed in the Republic of Korea on May 9, 2022, all of which are hereby expressly incorporated by reference into the present application.

### TECHNICAL FIELD

Embodiments relate to a lens driving device and camera module and an optical device including the same.

### BACKGROUND ART

Voice coil motor (VCM) technology, which is used in conventional general camera modules, is difficult to apply to a micro-scale camera module, which is intended to exhibit low power consumption, and study related thereto has been actively conducted.

There is increasing demand for, and production of, electronic products such as smart phones and cellular phones equipped with cameras. Cameras for cellular phones have been increasing in resolution and decreasing in size, and accordingly, an actuator therefor is also becoming smaller, larger in diameter, and more multifunctional. In order to realize a high-resolution cellular phone camera, improvement in the performance of the cellular phone camera and additional functions, such as auto-focusing, shutter shaking prevention, and zooming in and out, are required.

### DISCLOSURE

### Technical Problem

Embodiments provide a lens driving device capable of precisely controlling a vibration of the housing during OIS (Optical Image Stabilization) operation and increasing vibration absorption effect, and a camera device and optical device including the same.

### Technical Solution

A lens driving device according to embodiment may include a housing; a bobbin disposed in the housing and movable in an optical axis direction; an upper elastic member coupled with an upper portion of the bobbin and an upper portion of the housing; a circuit board disposed below the housing; a support member comprising one end coupled to the upper elastic member and the other end electrically connected to the circuit board; and a first damper coupled to at least a portion of the support member and the housing, wherein the first damper is spaced apart from the one end of the support member and is disposed closer to a lower surface of the housing than to an upper surface of the housing.

The housing may include a protruding portion protruding from an outer surface thereof, and the first damper may be disposed on the protruding portion.

The protruding portion may comprise a hole through which the support member passes, and wherein the first damper may be disposed in the hole.

The housing may comprise a recess formed at an upper surface of the protruding portion.

The lens driving device may comprise a first coil disposed on the bobbin; a magnet disposed on the housing; a second coil disposed under the magnet and configured to move the housing by an interaction with the magnet.

The lens driving device may comprise a lower elastic member coupled to a lower portion of the bobbin and a lower portion of the housing, wherein the first damper is positioned closer to the lower elastic member than the upper elastic member.

The lens driving device may comprise a second damper coupled to the upper elastic member and the housing, wherein the second damper is space apart from the first damper.

The first damper and the second damper may do not overlap in the optical axis direction.

The protruding portion of the housing may be positioned closer to the lower surface of the housing than the upper surface of the housing.

The housing may comprise a side portion and a corner portion, and the first damper is disposed on the corner portion of the housing.

The upper elastic member may include a first inner frame coupled with the bobbin, a first outer frame coupled with the housing, and a frame connection portion connecting the first inner frame and the first outer frame, and the second damper may be coupled with the first outer frame and spaced apart from the first inner frame and the frame connection portion.

A lens driving device according to another embodiment may include a housing; a bobbin disposed in the housing and movable in an optical axis direction; an upper elastic member coupled to an upper portion of the bobbin and an upper portion of the housing; a circuit board disposed below the housing; a support member including one end coupled with the upper elastic member and the other end electrically connected to the circuit board; a first damper coupled to at least a portion of the support member and the housing; and a second damper coupled to the upper elastic member and the housing, wherein the first damper is spaced apart from the one end of the support member, and the second damper is spaced apart from the first damper and spaced apart from the one end of the support member.

The first damper may be positioned lower than the second damper, and the first damper may overlap the one end of the support member in the optical axis direction, and the second damper may not overlap the one end of the support member in the optical axis direction.

The upper elastic member may include a first inner frame coupled with the bobbin, a first outer frame coupled with the housing, and a frame connection portion connecting the first inner frame and the first outer frame, and the first outer portion includes a first coupling portion coupled with the housing, a second coupling portion coupled with the one end of the support member, and a connection portion connecting the first coupling portion and the second coupling portion, and the second damper may be coupled with the connection portion, and the second damper may be spaced apart from the first inner frame, the frame connection portion, the first coupling portion, and the second coupling portion.

A lens driving device according to another embodiment includes a housing; a bobbin disposed in the housing and movable in an optical axis direction; an upper elastic member coupled to an upper portion of the bobbin and an upper portion of the housing; a circuit board disposed below the housing; a supporting member including one end coupled with the upper elastic member and the other end electrically connected to the circuit board; and a first damper coupled to at least a portion of the support member and the housing, wherein the housing includes a protruding portion protruding from an outer side surface thereof, and the first damper may be coupled with the protruding portion of the housing and spaced apart from the end of the support member.

A distance between a lower surface of the housing and the protruding portion in the optical axis direction may be smaller than a distance between an upper surface of the housing and the protruding portion in the optical axis direction.

### Advantageous Effects

Embodiments may enable independent and individual damper control for each of the upper elastic member and the support member, thereby enable precise control of the vibration of the housing during OIS operation.

Additionally, the embodiment may maximize the vibration absorption effect of the housing during OIS operation by using two independently divided dampers.

Additionally, in the embodiment, since the damper is disposed between the protruding portion of the housing and the support member, a contact area between the damper and the housing can be increased, and thus the vibration reduction effect on the housing or the vibration absorption effect on the housing can be increased.

Additionally, in the embodiment, since the damper is disposed in a groove formed at the protruding portion of the housing, the damper can be easily attached to or accommodated in the housing, and the damper can be prevented from being separated from the housing due to vibration of the housing.

Additionally, in the embodiment, since the damper is disposed in at least one hole formed at the protruding portion of the housing, the damper can be easily and firmly attached to the support member passing through the hole and the hole of the housing, and the damper can be prevented from being separated from the housing using by vibration of the housing.

### DESCRIPTION OF DRAWINGS

FIG. 1 is an exploded perspective view of a lens driving device according to an embodiment.

FIG. 2 is an assembled perspective view of the lens driving device, from which the cover member in FIG. 1 is removed.

FIG. 3A is an exploded perspective view of the bobbin, the first coil, and the sensing magnet.

FIG. 3B is an assembled perspective view of the bobbin, the first coil, and the sensing magnet.

FIG. 4A is a perspective view of the housing, the circuit board, the first position sensor, and the capacitor.

FIG. 4B is an exploded perspective view of the housing, the first to third magnet units, and the dummy member.

FIG. 4C is an assembled perspective view of the housing, the first to third magnet units, the dummy member, the circuit board, and the first position sensor.

FIG. 5A is an enlarged view of a portion of the housing in FIG. 4A.

FIG. 5B is a bottom view of FIG. 5a.

FIG. 6A is a perspective view showing the upper elastic member.

FIG. 6B is a perspective view showing the lower elastic member.

FIG. 7A is a first perspective view for describing an electrical connection between the upper elastic member, the first circuit board, the support member, and the second circuit board.

FIG. 7B is a perspective view in another direction of FIG. 7A.

FIG. 8 is an exploded perspective view of the second circuit board, the second coil, the second position sensor, the base, and the terminal member.

FIG. 9A is a perspective view of the second circuit board.

FIG. 9B is a bottom view of the second circuit board of FIG. 9A.

FIG. 9C is for describing an electrical connection between the second coil, the second circuit board, and the terminal member.

FIG. 10A is a cross-sectional view of the lens driving device shown in FIG. 2 taken in the direction AB.

FIG. 10B is a cross-sectional view of the lens driving device shown in FIG. 2 taken in the direction CD.

FIG. 10C is a cross-sectional view of the lens driving device shown in FIG. 2 taken in the direction EF.

FIG. 11 is a perspective view of the first to third magnet units, coil units, and the dummy member.

FIG. 12 is a front view of the first to third magnet units, coil units, and the dummy member of FIG. 11.

FIG. 13 is a plan view of the first to third magnet units, coil units, and the dummy member of FIG. 11.

FIG. 14 is a perspective view of the base.

FIG. 15 is a perspective view of the terminal member.

FIG. 16 is an assembled perspective view of the base, the terminal member, the second coil, and the second position sensor.

FIG. 17 is an assembled perspective view of the base, the terminal member, the second coil, the second position sensor, and the second circuit board.

FIG. 18 is a perspective view of a portion of the lens driving device in FIG. 2.

FIG. 19 is a perspective view in another direction of a portion of the lens driving device in FIG. 18.

FIG. 20 is a cross-section view of the lens driving device in FIG. 18.

FIG. 21 is a cross-section view of the lens driving device according to another embodiment

FIG. 22 is an exploded perspective view of a camera device according to an embodiment.

FIG. 23 is an exploded perspective view of a camera device according to another embodiment.

FIG. 24A is a perspective view of an optical device according to an embodiment.

FIG. 24B is a perspective view of an optical device according to another embodiment.

FIG. 25 is a configuration diagram of the optical device shown in FIG. 24A and FIG. 24B.

### BEST MODE

Hereinafter, exemplary embodiments of the present disclosure will be described in detail with reference to the accompanying drawings.

The technical spirit of the disclosure is not limited to the embodiments to be described, and may be implemented in various other forms, and one or more of the components may be selectively combined and substituted for use without exceeding the scope of the technical spirit of the disclosure.

In addition, terms (including technical and scientific terms) used in the embodiments of the disclosure, unless specifically defined and described explicitly, are to be interpreted as having meanings that may be generally understood by those having ordinary skill in the art to which the disclosure pertains, and meanings of terms that are commonly used, such as terms defined in a dictionary, should be interpreted in consideration of the context of the relevant technology.

Further, the terms used in the embodiments of the disclosure are for explaining the embodiments and are not intended to limit the disclosure. In this specification, the singular forms may also include plural forms unless otherwise specifically stated in a phrase, and in the case in which “at least one (or one or more) of A, B, or C” is stated, it may include one or more of all possible combinations of A, B, and C.

In addition, in describing the components of the embodiments of the disclosure, terms such as “first”, “second”, “A”, “B”, “(a)”, and “(b)” can be used. Such terms are only for distinguishing one component from another component, and do not determine the nature, sequence, or procedure of the corresponding constituent elements.

In addition, when it is described that a component is “connected”, “coupled” or “joined” to another component, the description may include not only being directly “connected”, “coupled” or “joined” to the other component but also being “connected”, “coupled” or “joined” by another component between the component and the other component. In addition, in the case of being described as being formed or disposed “above (on)” or “below (under)” another component, the description includes not only the case where the two components are in direct contact with each other, but also the case where one or more other components are formed or disposed between the two components. In addition, when expressed as “above (on)” or “below (under)”, it may refer to a downward direction as well as an upward direction with respect to one element.

Hereinafter, the “lens driving device” may be referred to as a “lens moving unit”, a “voice coil motor (VCM)”, an “actuator” or a “lens moving device”. Hereinafter, the “coil” may be referred to as a “coil unit”, and the “elastic member” may be referred to as an “elastic unit” or a “spring”.

In the following description, the “terminal” may be referred to as a “pad”, an “electrode”, a “conductive layer” or a “bonding portion”.

For the convenience of description, although the lens driving device according to an embodiment will be described using the Cartesian coordinate (x, y, z), the lens driving device may be described using some other coordinate systems, and the embodiments are not limited thereto. In the drawings, the X-axis direction and the Y-axis direction are directions perpendicular to the Z-axis direction, which is an optical-axis direction. The Z-axis direction, which is the direction of the optical axis OA, may be referred to as a “first direction”, the X-axis direction may be referred to as a “second direction”, and the Y-axis direction may be referred to as a “third direction”. For example, the optical axis may be an optical axis of the lens or the lens module.

The lens driving device according to an embodiment may perform an “auto-focusing function”. Here, the “auto-focusing function” serves to automatically focus an image of a subject on the surface of an image sensor.

In addition, the lens driving device according to the embodiment may perform a “handshake correction function”. Here, the “handshake correction function” may serve to prevent the contour line of a captured image from being blurred due to vibration caused by shaking of the user's hand when capturing a still image.

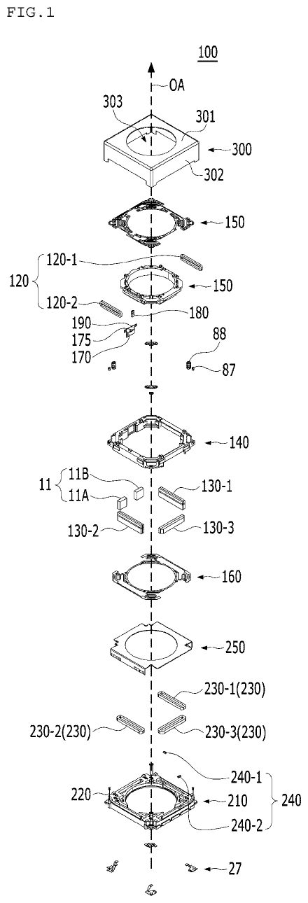

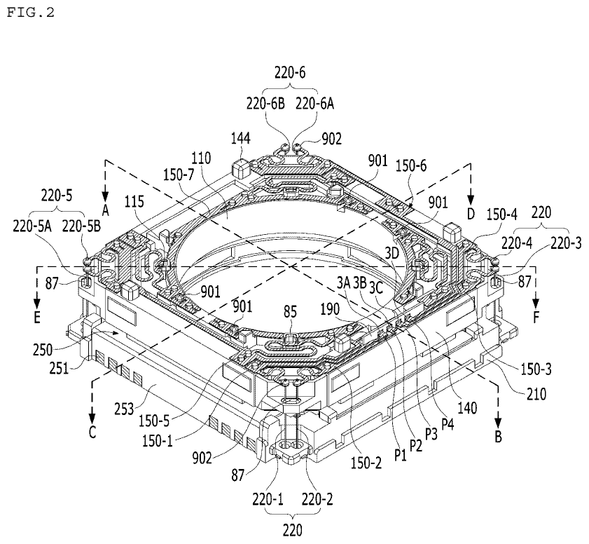

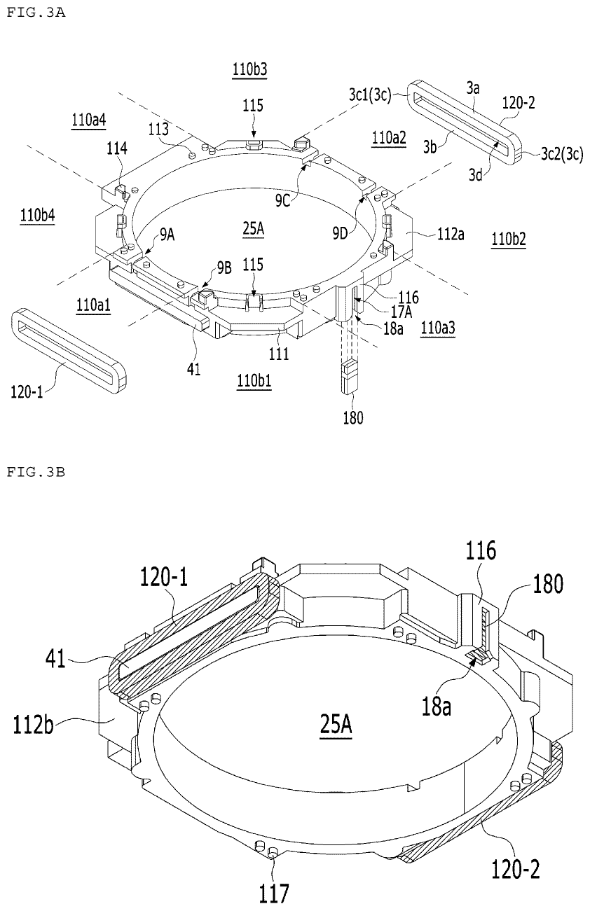

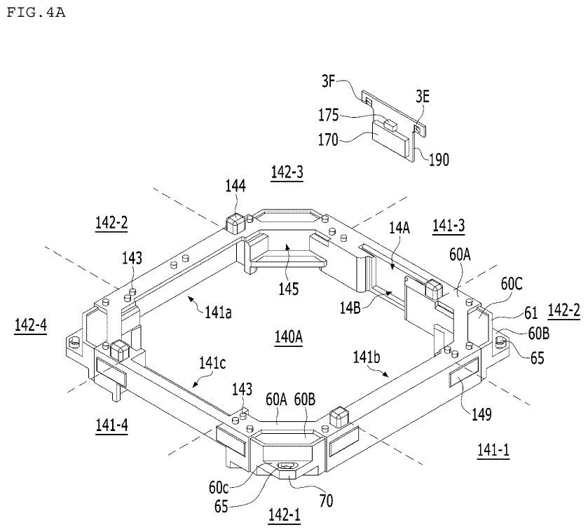

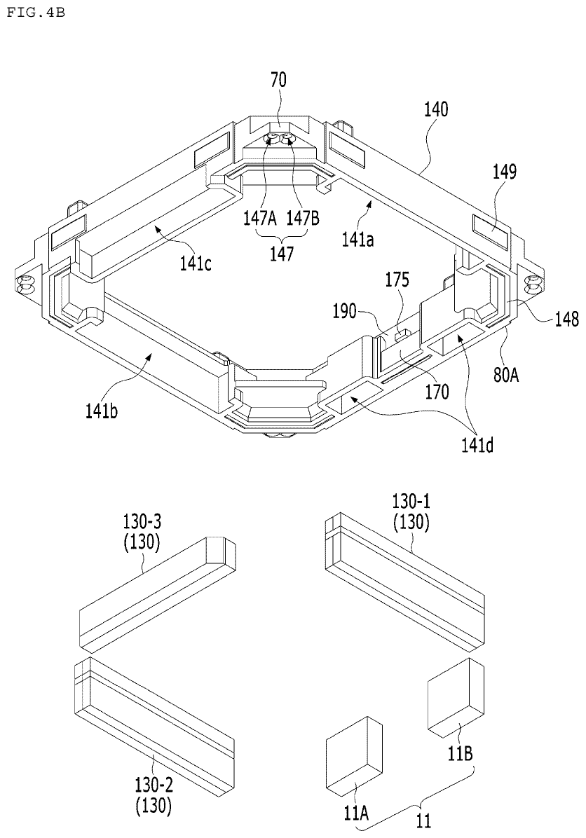

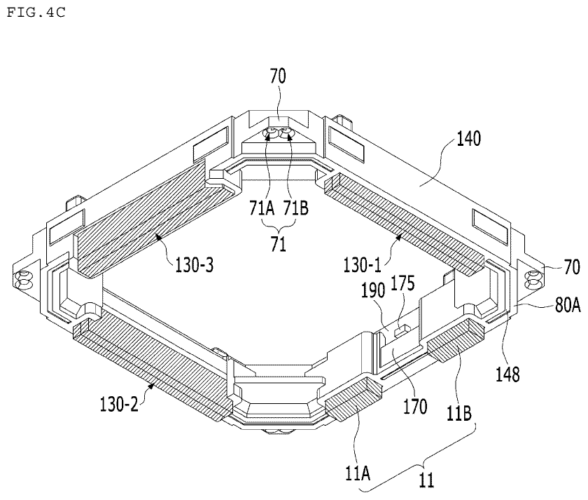

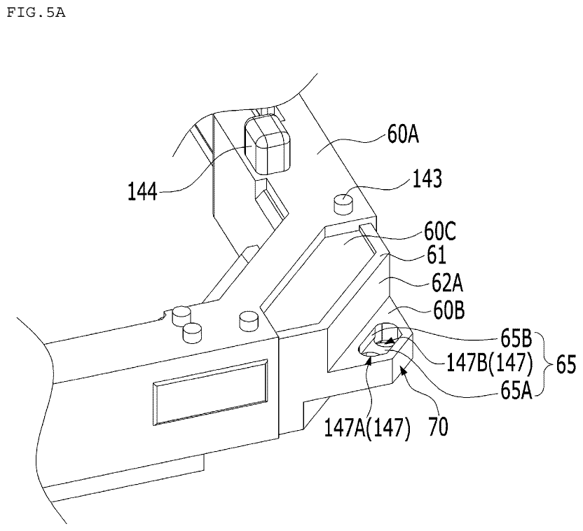

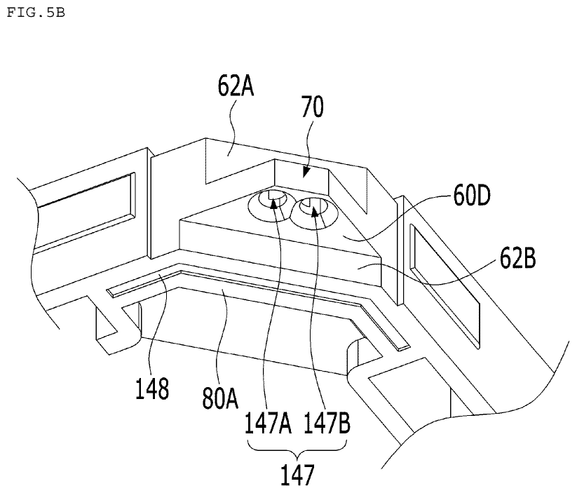

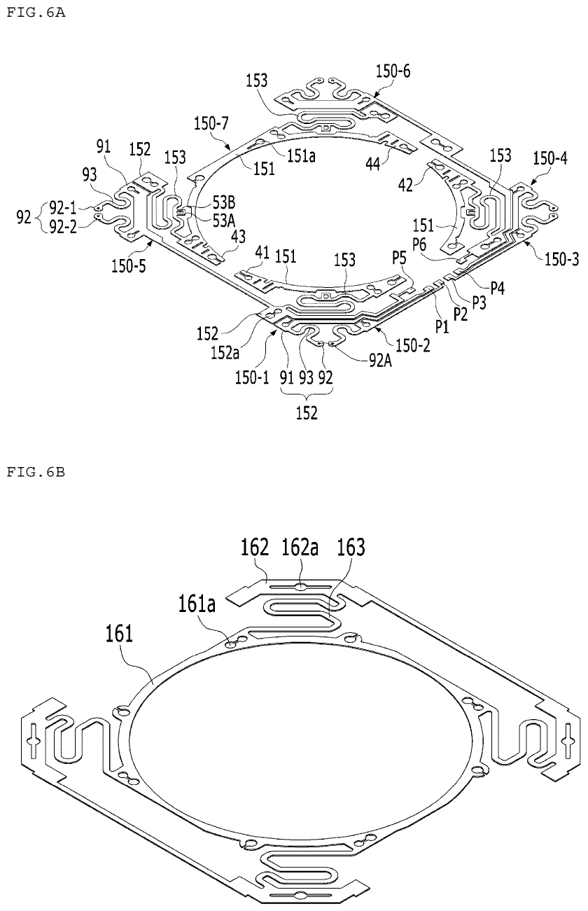

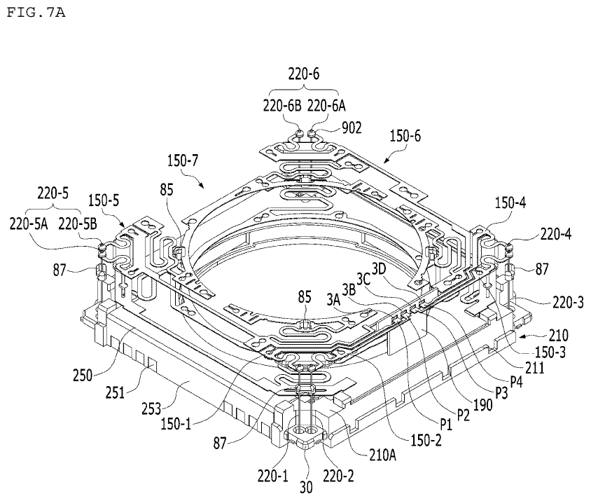

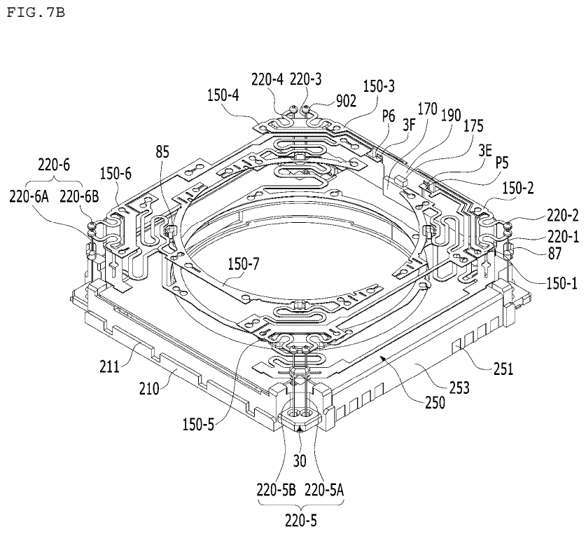

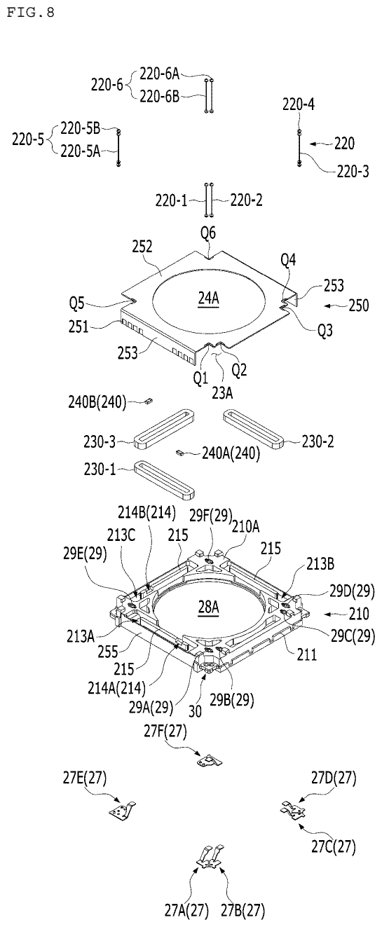

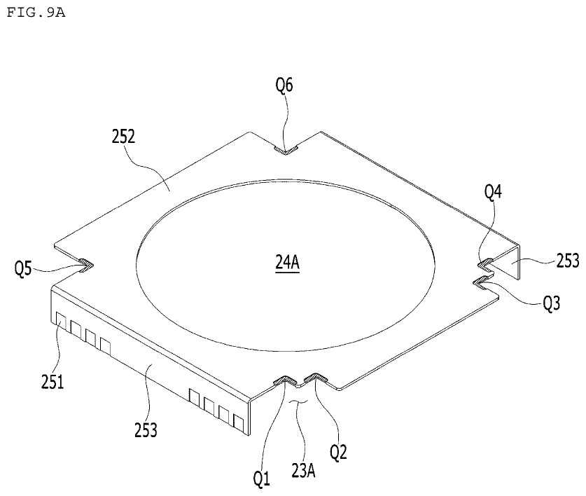

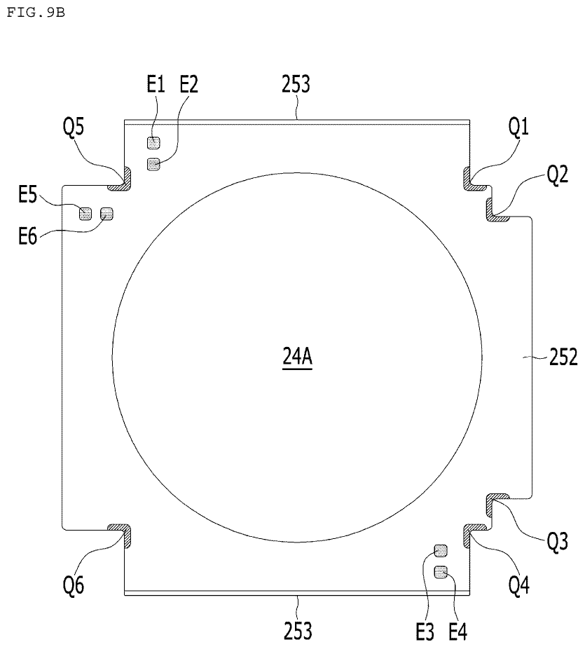

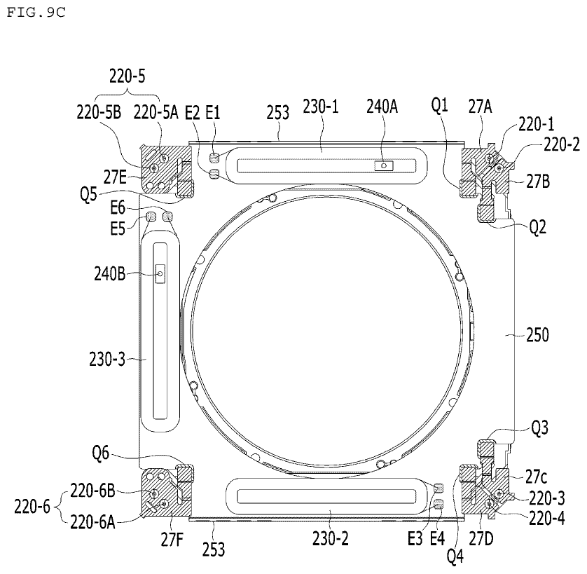

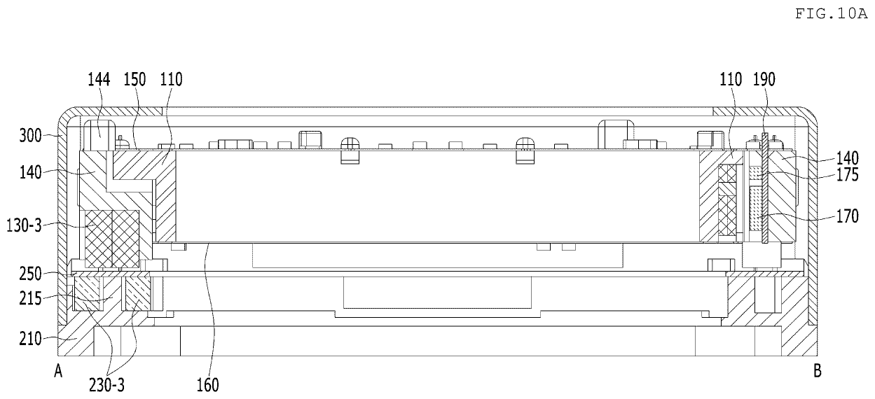

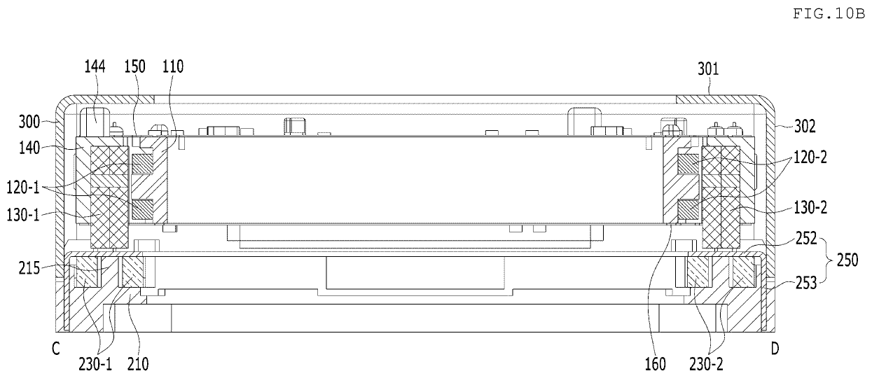

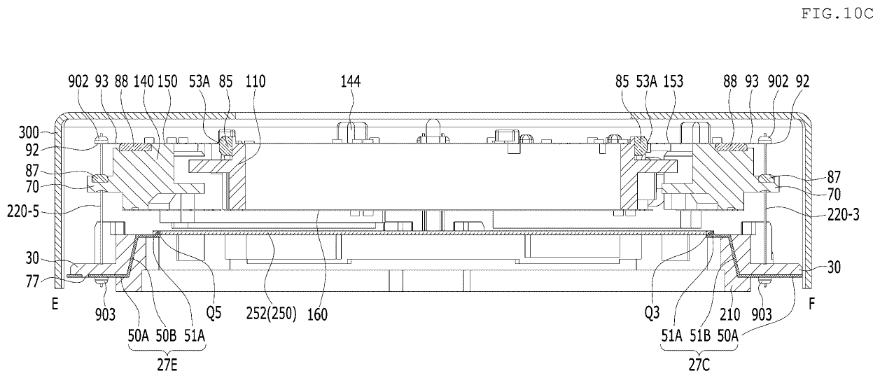

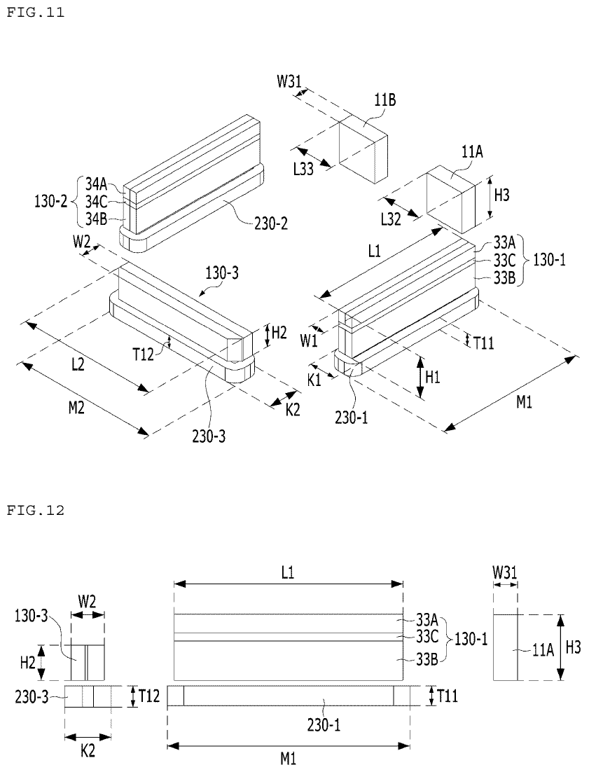

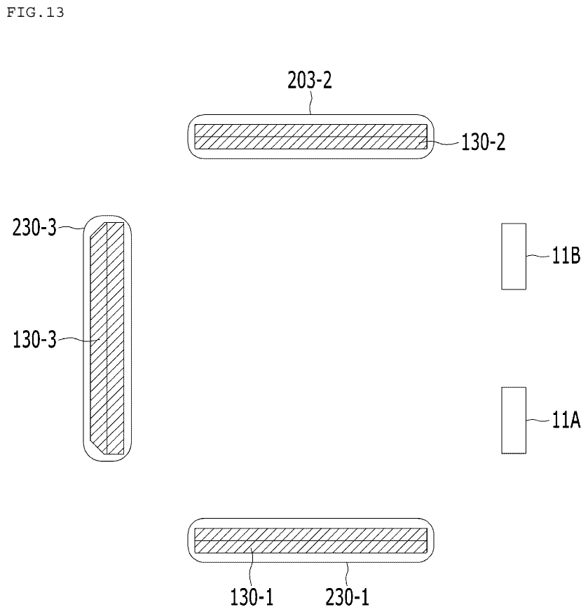

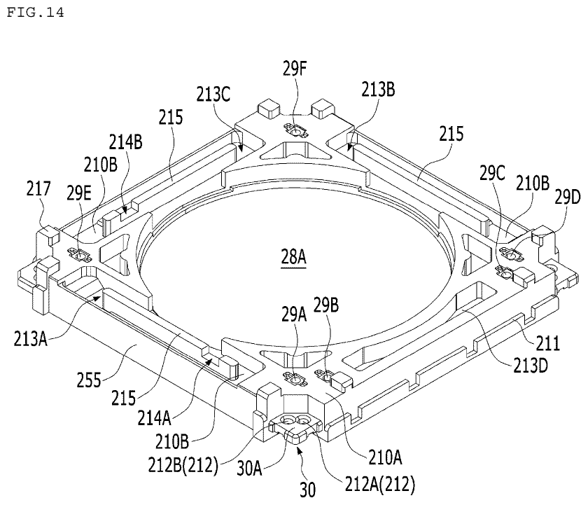

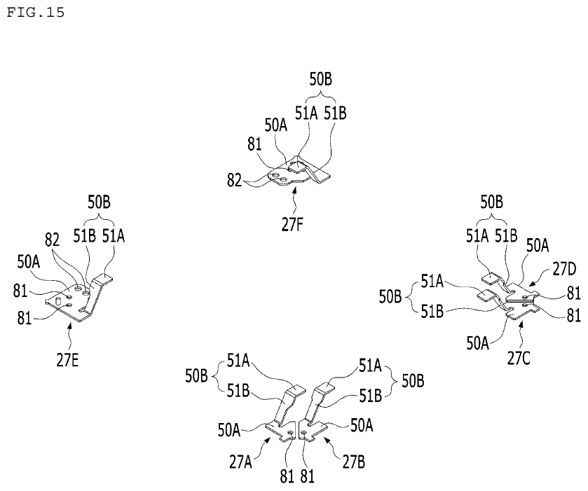

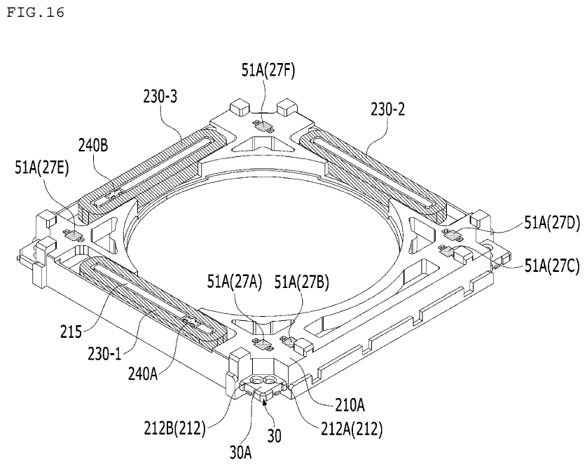

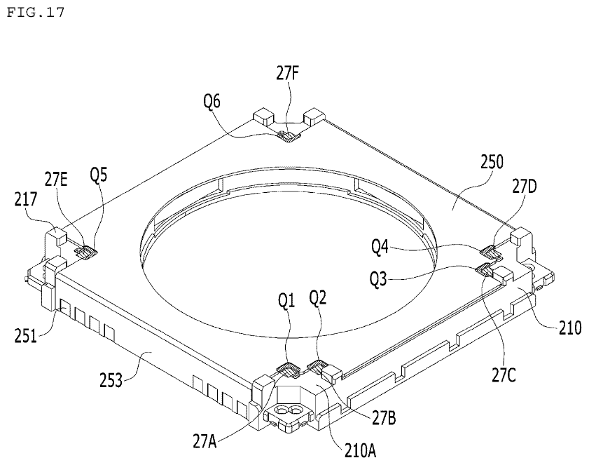

FIG. 1 is an exploded perspective view of a lens driving device 100 according to an embodiment, FIG. 2 is an assembled perspective view of the lens driving device 100, from which the cover member 300 in FIG. 1 is removed, FIG. 3A is an exploded perspective view of the bobbin 110, the first coil 120, and the sensing magnet 180, FIG. F 3B is an assembled perspective view of the bobbin 110, the first coil 120, and the sensing magnet 180, FIG. 4A is a perspective view of the housing 140, the circuit board 190, the first position sensor 170, and the capacitor 175, FIG. 4B is an exploded perspective view of the housing 140, the first to third magnet units 130-1 to 130-3, and the dummy member 11, FIG. 4C is an assembled perspective view of the housing 140, the first to third magnet units 130-1 to 130-4, the dummy member 11, the circuit board 190, and the first position sensor 170, FIG. 5A is an enlarged view of a portion of the housing 140 in FIG. 4A, FIG. 5B is a bottom view of FIG. 5a, FIG. 6A is a perspective view showing the upper elastic member 150, FIG. 6B is a perspective view showing the lower elastic member 160, FIG. 7A is a first perspective view for describing an electrical connection between the upper elastic member 150, the first circuit board 190, the support member 220, and the second circuit board 250, FIG. 7B is a perspective view in another direction of FIG. 7A, FIG. 8 is an exploded perspective view of the second circuit board 250, the second coil 230, the second position sensor 240, the base 210, and the terminal member 27, FIG. 9A is a perspective view of the second circuit board 250, FIG. 9B is a bottom view of the second circuit board 250 of FIG. 9A, FIG. 9C is for describing an electrical connection between the second coil 230, the second circuit board 250, and the terminal member 27, FIG. 10A is a cross-sectional view of the lens driving device shown in FIG. 2 taken in the direction AB, FIG. 10B is a cross-sectional view of the lens driving device shown in FIG. 2 taken in the direction CD, FIG. 10C is a cross-sectional view of the lens driving device shown in FIG. 2 taken in the direction EF, FIG. 11 is a perspective view of the first to third magnet units 130-1 to 130-3, coil units 230-1 to 230-3, and the dummy member 11, FIG. 12 is a front view of the first to third magnet units 130-1 to 130-3, coil units 230-1 to 230-3, and the dummy member 11 of FIG. 11, FIG. 13 is a plan view of the first to third magnet units 130-1 to 130-3, coil units 230-1 to 230-3, and the dummy member 11 of FIG. 11, FIG. 14 is a perspective view of the base 210, FIG. 15 is a perspective view of the terminal member 27, FIG. 16 is an assembled perspective view of the base 210, the terminal member 27, the second coil 230, and the second position sensor 240, FIG. 17 is an assembled perspective view of the base 210, the terminal member 27, the second coil 230, the second position sensor 240, and the second circuit board 250.

Referring to FIGS. 1 to 17, the lens driving device 100 may include a housing 140, a bobbin 110 disposed in the housing 140, and an upper elastic member 150 coupled to at least one of the housing 140 and the bobbin 110, a support member 220 coupled to the upper elastic member 150 and supporting the housing 140, and a damper 87 disposed between the housing 140 and the support member 220 and including at least a portion that is coupled to, in contact with, or attached to the housing 140 and the support member 220.

The lens driving device 100 may further include a first coil 120 and a magnet 130 to move the bobbin 110 in the optical axis direction. The lens driving device 100 may further include a lower elastic member 160 that is spaced apart from the upper elastic member 150 and is coupled to at least one of the housing 140 and the bobbin 110. The lens driving device 100 may further include a dummy member 11 disposed at the housing 140. The lens driving device 100 may include at least one of a base 210 and a cover member 300.

The lens driving device 100 may further include a first position sensor 170 and a sensing magnet 180 for AF feedback driving. The lens driving device 100 may further include a capacitor 175 conductively connected to the first position sensor 170. The lens driving device 100 may further include a first circuit board 190 conductively connected to the first position sensor 170.

The lens driving device 100 may further include a second circuit board 250 conductively connected to the support member 220. The lens driving device 100 may include a second coil 230 that corresponds to, faces, or overlaps the magnet 130 in order to move the housing 140. The lens driving device 100 may further include a second position sensor 240 conductively connected to the second circuit board 250 for OIS feedback driving. The lens driving device 100 may further include a terminal member 27 conductively connected to the support member 220 and the second circuit board 250.

Referring to FIGS. 1 to 3B, the bobbin 110 may be disposed inside the housing 140. For example, the bobbin 110 may be disposed in a hollow (or through hole) 140A of the housing 140.

The bobbin 110 may be moved in the optical axis direction or in the first direction. For example, the bobbin 110 may be moved in the optical axis OA direction or in the first direction (e.g., Z-axis direction) by electromagnetic interaction between the first coil 120 and the magnet 130.

The bobbin 110 may have an opening 25A for mounting the lens module 400. For example, the lens module 400 may include at least one of at least one lens and a lens barrel.

For example, the opening 25A of the bobbin 110 may be in a form of a through hole penetrating the bobbin 110, and a shape of the opening of the bobbin 110 may be circular, elliptical, or polygonal, but is not limited thereto.

The bobbin 110 may include first side portions 110a1 to 110a4 spaced apart from each other and second side portions 110b1 to 110b4 spaced apart from each other. Each of the second side portions 110b1 to 110b4 may connect two adjacent first side portions to each other. For example, the first side portions 110a1 to 110a4 of the bobbin 110 may be expressed as “side portions,” and the second side portions 110b1 to 110b4 of the bobbin 110 may be expressed as “corner portions” or “corners.”

A seating portion for seating the first coil may be provided on the side portion (or side surface) of the bobbin 110. For example, a first seating portion 41 for mounting, seating, or disposing the first coil unit 120-1 may be provided at one of the side portions of the bobbin 110 (e.g., the first side portion 110a1), and a second seating portion 42 for mounting, seating, or disposing the second coil unit 120-2 may be provided at any other of the side portions of the bobbin 110 (e.g., the second side portion 110a2).

For example, the first seating portion 41 and the second seating portion 42 may be provided at two side portions 110a1 and 110a2 of the bobbin 110 that are located opposite to each other.

Each of the first seating portion 41 and the second seating portion 42 may include at least one protrusion protruding from an outer surface of the bobbin 110, but is not limited thereto. In another embodiment, each of the first and second seating portions may be in a form of a groove recessed from the outer surface of the bobbin 110.

The first coil unit 120-1 may be coupled to the first seating portion 41, and the second coil unit 120-2 may be coupled to or wound with the second seating portion 42.

The bobbin 110 may include a groove for mounting or disposing the sensing magnet 180. For example, the bobbin 110 may comprise a groove 18a or a hole provided on another one of the side portions (e.g., the third side portion 110a3) thereof for mounting or disposing the sensing magnet 180. For example, the third side portion 110a3 of the bobbin 110 may be a side portion where the first coil unit 120-1 or the second coil unit 120-2 of the first coil 120 is not disposed.

A protruding portion 116 for placing the sensing magnet 180 may be formed at the third side portion 110a3 of the bobbin 110 so as to protrude in a direction perpendicular to the optical axis. The groove 18a may be formed at the protruding portion 116. For example, the groove 18a may be formed on a lower surface of the protruding portion 116, but the present invention is not limited thereto. In another embodiment, the groove may be formed on at least one of an upper surface and a side surface of the protruding portion 116. For example, the protruding portion 116 may include an opening 17A to expose at least a portion of the sensing magnet 180.

Also, like the protrusion 111 of the bobbin 110, the protruding portion 116 can suppress or prevent the bobbin 110 from rotating beyond a certain range around the optical axis. The bobbin 110 may include protrusions 111 provided at corner portions 110b1 to 110b4. The protrusion 111 may protrude in a direction parallel to a straight line passing through the optical axis OA and perpendicular to the optical axis direction, but is not limited thereto.

The protrusion 111 of the bobbin 110 corresponds to a groove 145 of the housing 140, and may be inserted or disposed within the groove 145 of the housing 140, and suppress or prevent the bobbin 110 from moving or rotating beyond a certain range around the optical axis.

An escape groove 112a may be provided on the upper surface of the bobbin 110 to avoid spatial interference with a first frame connection portion 153 of the upper elastic member 150. A second escape groove 112b may be provided on the lower surface of the bobbin 110 to avoid spatial interference with a second frame connection portion 163 of the lower elastic member 160. For example, the first and second escape grooves 112a and 112b may be disposed on the corner portions 110b1 to 110b4 of the bobbin 110, but are not limited thereto, and may be disposed on at least one of the side portions and corner portions of the bobbin 110.

The bobbin 110 may include a first stopper 114 protruding from the upper surface thereof. Although not shown in FIG. 3B, the bobbin 110 may include a second stopper protruding from the lower surface 10B thereof.

When the bobbin 110 moves in the first direction for the auto-focusing function, the first stopper 114 and the second stopper of the bobbin 110 may prevent the upper surface of the bobbin 110 from directly colliding with an inside of the upper plate 301 of the cover member 300 and to prevent the lower surface of the bobbin 110 from directly colliding with the second circuit board 250, even if the bobbin 110 moves beyond a specified range due to an external impact, etc.

A first coupling portion 113 may be provided on the upper surface of the bobbin 110 to be coupled to and fixed to the upper elastic member 150, and a second coupling portion 117 may be provided on the lower surface 10B of the bobbin 110 to be coupled to the lower elastic member 160.

For example, in FIGS. 3A and 3B, the first and second coupling portions 113 and 117 of the bobbin 110 may be a protrusion shape, but this is not limited to this, and in another embodiment, the first and second coupling portions of the bobbin 110 may be a groove or planar shape.

In addition, when the first and second coil units 120-1 and 120-2 is connected or combined with the upper elastic member 150 by a conductive adhesive member such as solder, the bobbin 110 may comprise guide groove 9A to 9D formed on the upper surface of two side portions 110a1, 110a2 thereof located on opposite sides of each other to prevent the first and second coil units 120-1 and 120-2 from being separated from the bobbin and to guide both ends of the first and second coil units 120-1, 120-2.

For example, one end of the first coil unit 120-1 may pass through the guide groove 9A and be coupled to the third upper elastic members 150-3, and the other end of the first coil unit 120-1 may pass through the guide groove 9B and be coupled to the first upper elastic member 150-1. Also, for example, one end of the second coil unit 120-2 may pass through the guide groove 9C and be coupled to the third upper elastic member 150-3, and the other end of the second coil unit 120-2 may pass through the guide groove 9D and be coupled to the second upper elastic member 150-2.

Next, the first coil 120 will be described.

The first coil 120 may be disposed on the bobbin 110 or may be coupled with the bobbin 110.

The first coil 120 includes first and second coil units 120-1 and 120-2 disposed on two opposite side portions (e.g., 110a, 110b) of the bobbin 110. Here, the coil unit may be expressed as a “coil part,” “coil block,” or “coil ring.”

For example, the first coil unit 120-1 may be disposed at or coupled to the first seating portion 41 of the bobbin 110, and the second coil unit 120-2 may be disposed at or coupled to the second seating portion 42 of the bobbin 110.

Each of the first coil unit 120-1 and the second coil unit 120-2 may include at least one of an elliptical shape and a closed curve shape. For example, each of the first coil unit 120-1 and the second coil unit 120-2 is a form of coil ring wound rotating about an axis passing through a center of the opening 25A of the bobbin 110 and perpendicular to the optical axis OA.

For example, each of the first coil unit 120-1 and the second coil unit 120-2 include a first part 3a, a second part 3b disposed under the first part 3a, and a connection part 3c connecting the first part 3a and the second part 3b, and a closed curve can be formed by the first to third parts 3a, 3b, and 3c. For example, each of the first coil unit 120-1 and the second coil unit 120-2 may include a center hole 3d.

The third part 3c includes a first connecting part 3cl connecting one end of the first part 3a and one end of the second part 3b, and a second connecting part 3c2 connecting the other end of the first part 3a and the other end of the second part 3b.

For example, the first part 3a may be expressed as a “first straight part,” the second part 3b may be expressed as a “second straight part,” and the third part 3c may be expressed as a “curved part.””, the first connecting part 3cl may be expressed as a first curved part, and the second connecting part 3c2 may be expressed as a second curved part.

For example, the first coil unit 120-1 and the second coil unit 120-2 may be connected in series. For example, the first coil unit 120-1 and the second coil unit 120-2 may be connected in series to each other by the upper elastic member 150, but this is not limited to this. Both may be connected in series to each other by at least one of the upper elastic member and the lower elastic member.

In another embodiment, the first coil unit and the second coil unit may be connected in series to each other by a connection coil or connection part. For example, one end of the connection coil may be directly connected to one end of the first coil unit, and the other end of the connection coil may be connected to one end of the second coil unit.

In another embodiment, the first coil unit 120-1 and the first coil unit 120-2 may be conductively separated or spaced apart from each other, and may be individually driven.

In another embodiment, the first coil may have a closed curve, for example, a ring shape, wound around an outer peripheral surface of the bobbin 110 with respect to the optical axis (or the central axis).

When a driving signal (e.g., driving current) is supplied to the first coil 120, electromagnetic force may be formed through electromagnetic interaction between the first coil 120 and the magnet 130, and the bobbin 110 may be moved in the optical axis direction OA by the electromagnetic force. For example, the bobbin 110 may be moved by the electromagnetic force between the first coil unit 120-1 and the first magnet unit 130-1 and the electromagnetic force between the second coil unit 120-2 and the second magnet unit 130-2.

From an initial position of the AF movable unit, the bobbin 110 may be moved in an upward or downward direction (e.g., Z-axis direction), which is referred to as bidirectional driving of the AF movable unit. Alternatively, in the initial position of the AF movable unit, the bobbin 110 may be moved in an upward direction, which is referred to as unidirectional driving of the AF movable unit.

In the initial position of the AF movable unit, the first coil unit 120-1 may face or overlap the first magnet unit 130-1 in a first horizontal direction 201, but may not face or overlap the third magnet unit 130-3. For example, the first horizontal direction may be a direction which is perpendicular to the optical axis OA and toward the first coil unit 120-1 from the optical axis OA.

In the initial position of the AF movable unit, the second coil unit 120-2 may face or overlap the second magnet unit 130-2 in the first horizontal direction, but may not face or overlap the third magnet unit 130-3.

The AF movable unit may include the bobbin 110 and components coupled to the bobbin 110. For example, the AF movable unit may include the bobbin 110, the first coil 120, and the sensing magnet 180. Additionally, the AF movable unit may further include the lens module 400 mounted on the bobbin 110.

And the initial position of the AF movable unit is an original position of the AF movable unit in a state where no power is supplied to the first coil 120, or a position at which the AF operation unit is located as the result of the upper and lower elastic members 150 and 160 being elastically deformed due only to the weight of the AF operation unit.

In addition, the initial position of the bobbin 110 may be a position at which the AF operation unit is located when gravity acts in the direction from the bobbin 110 toward the base 210 or when gravity acts in the direction from the base 210 toward the bobbin 110.

The sensing magnet 180 provides a magnetic field for the first position sensor 170 to sense. The sensing magnet 180 may be disposed on the bobbin or coupled with the bobbin 110. For example, the sensing magnet 180 may be disposed on the protruding portion 116 of the bobbin 110. For example, the sensing magnet 180 may be coupled with the protruding portion 116 of the bobbin 110. For example, at least a portion of the sensing magnet 180 may be disposed in the groove 18a of the protruding portion 116 and may be coupled with the groove 18a using an adhesive or the like. The sensing magnet 180 may be disposed to correspond to or face the first position sensor 170 in the optical axis direction OA.

At least a portion of one side (e.g., lower surface) of the sensing magnet 180 corresponding to the first position sensor 170 may be exposed outside the groove 18a of the bobbin 110, but is not limited to this. In another embodiment, one side of the sensing magnet 180 facing the first position sensor 170 may not be exposed from the bobbin 110.

For example, a boundary surface of the N pole and the S pole of the sensing magnet 180 disposed on the bobbin 110 may be parallel to a direction perpendicular to the optical axis OA. For example, the N and S poles of the sensing magnet 180 may face each other in the optical axis direction, but are not limited to this.

In another embodiment, the sensing magnet may be disposed so that the N pole and the S pole thereof face each other in a direction perpendicular to the optical axis. For example, in another embodiment, the boundary surface between the N pole and the S pole of the sensing magnet 180 disposed on the bobbin 110 may be parallel to the optical axis OA.

For example, the sensing magnet 180 may be a unipolar magnetized magnet having one N pole and one S pole, but is not limited thereto. In another embodiment, the sensing magnet 180 may be a bipolar magnetized magnet or a four-pole magnet including two N poles and two S poles.

For example, the sensing magnet 180 includes a first magnet portion including an N pole and an S pole, a second magnet portion including an S pole and an N pole, and a partition wall disposed between the first magnet portion and the second magnet portion. For example, the partition wall may be a “non-magnetic partition wall”. For example, the first magnet portion may be disposed on the second magnet portion, and the N pole (or S pole) of the first magnet portion may be disposed to face the S pole (or N pole) of the second magnet portion. For example, the first magnet portion and the second magnet portion may be located on opposite sides of each other in the optical axis direction with the partition between them, and may be arranged so that opposite polarities face each other. For example, a length of the first magnet portion in the optical axis direction may be different from a length of the second magnet portion in the optical axis direction. For example, the length of the first magnet portion in the optical axis direction may be greater than the length of the second magnet portion in the optical axis direction. In another embodiment, the length of the first magnet portion in the optical axis direction may be smaller than or equal to the length of the second magnet portion in the optical axis direction.

For example, by varying the optical axis length of the N/S pole of the first magnet portion of the sensing magnet 180 and the optical axis length of the S/N pole of the second magnet portion, the magnetic field value (or magnetic force) detected by the position sensor 170 may have a N-pole (+), an S-pole (−), or a mixture of N-pole and S-pole.

In addition, the contents described later regarding the magnet 130 implemented as a bipolar magnetization can be applied or inferred to the sensing magnet.

A shape of the sensing magnet 180 may be a cylinder, a cylindrical shape, a semi-circular pillar, or a polyhedron shape (e.g., a hexahedron), but is not limited thereto.

For example, the length of the sensing magnet 180 in the optical axis direction may be greater than the length of the sensing magnet 180 in the direction perpendicular to the optical axis. In another embodiment, the length of the sensing magnet 180 in the optical axis direction may be equal to or smaller than the length in the direction perpendicular to the optical axis.

When the sensing magnet 180 has a cylindrical or cylindrical shape, the magnetic field distribution of the sensing magnet 180 detected by the first position sensor 170 may be uniform, and this can lead to improve the sensitivity of the first position sensor 170.

For example, a cross-sectional shape of the sensing magnet 180 cut in a direction perpendicular to the optical axis may be circular, oval, or polygonal (e.g., triangular or square).

In another embodiment, the first position sensor may be disposed on the bobbin 110, and the sensing magnet may be disposed on the housing 140 to correspond to, face, or overlap the first position sensor in the direction perpendicular to the optical axis.

In another embodiment, the sensing magnet may be disposed on the bobbin 110, and the first position sensor may be disposed on the base 210 to correspond to, face, or overlap the sensing magnet in the optical axis direction.

In another embodiment, the sensing magnet may be disposed on the second circuit board 250 or the base 210, and the first position sensor may be disposed on the bobbin 110.

In another embodiment, the lens driving device 100 may include a balancing magnet disposed on the bobbin 110 to cancel the magnetic field influence of the sensing magnet 180 and balance the weight of the sensing magnet 180. For example, the balancing magnet may be positioned opposite to the sensing magnet 180 based on the optical axis.

Referring to FIGS. 4A to 4C, the housing 140 accommodates at least a portion of the bobbin 110 inside. The housing 140 is configured to support the magnet 130. For example, the housing 140 may support the magnet units 130-1 to 130-3 of the magnet 130 and the dummy member 11.

The housing 140 may be expressed as an ‘OIS movable unit’. The OIS movable unit may be moved together with the AF movable unit by electromagnetic force generated by an interaction between the magnet 130 and the second coil 230. For example, the housing 140 may be disposed inside the cover member 300. For example, the housing 140 may be disposed between the cover member 300 and the bobbin 110.

An outer surface of the housing 140 may be spaced apart from an inner surface of the side plate 302 of the cover member 300. Since a separation space exists between the housing 140 and the cover member 300, the housing 140 can be moved in a direction perpendicular to the optical axis by the electromagnetic force between the magnet 130 and the second coil 230.

Housing 140 may include an opening or hollow 140A. For example, the housing 140 may have a hollow pillar shape. For example, the housing 140 may have a polygonal (e.g., square or octagonal) or circular opening 140A.

Housing 140 may include a side portion and a corner portion. For example, the housing 140 may include a plurality of side portions 141-1 to 141-4 and a plurality of corner portions 142-1 to 142-4. For example, the housing 140 may include first to fourth side portions 141-1 to 141-4 and first to fourth corner portions 142-1 to 142-4. For example, the first to fourth side portions 141-1 to 141-4 may be spaced apart from each other. Each of the corner portions 142-1 to 142-4 of the housing 140 may be disposed or located between two adjacent side portions, and may connect the side portions 141-1 to 141-4.

For example, the corner portions 142-1 to 142-4 may be located at a corner or edge of the housing 140. For example, the number of side portions of the housing 140 is four and the number of corner portions is four, but the number is not limited thereto.

Each of the side portions 141-1 to 141-4 of the housing 140 may be disposed parallel to a corresponding one of the side plates 302 of the cover member 300.

A horizontal length of each of the side portions 141-1 to 141-4 of the housing 140 may be greater than a horizontal length of each of the corner portions 142-1 to 142-4, but is not limited thereto. For example, the first side portion 141-2 and the second side portion 141-2 of the housing 140 may be positioned opposite to each other, and the third side portion 141-3 and the fourth side portion 141-4 may be positioned opposite to each other. Each of the third side portion 141-3 and the fourth side portion 141-4 of the housing 140 may be located between the first side portion 141-2 and the second side portion 141-2.

In order to prevent the cover member 300 from colliding directly with an inner surface of the upper plate 301, the housing 140 may include a stopper 144 disposed on an upper portion, an upper end, or an upper surface thereof. For example, the stopper 144 may protrude upward from the upper surface of the housing 140 and may be disposed or arranged on at least one of the side portion and corner portion of the housing 140.

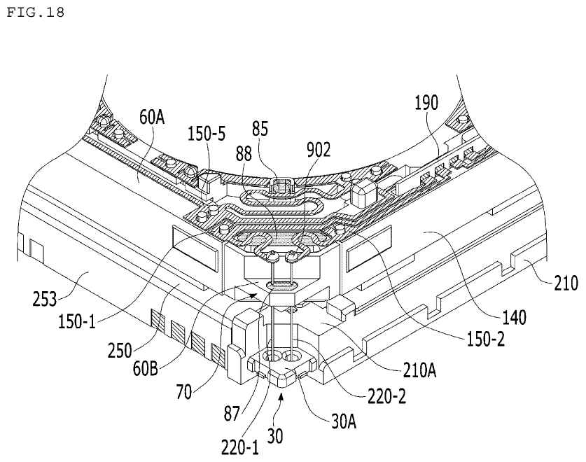

In addition, the housing 140 may include a protrusion 61 or a step provided at the corner portions 142-1 to 142-4 of the housing 140 to guide a placement of the damper 88 (see FIG. 18) in contact with the upper elastic member 150 and to prevent the damper 88 from overflowing.

The housing 140 may include at least one first coupling portion 143 that is disposed or formed on the upper portion, the upper end, or the upper surface thereof and is coupled with the upper elastic member 150 (e.g., first outer frame 152).

In addition, the housing 140 may include at least one second coupling portion 148 that is disposed or formed on a lower portion, a lower end, or a lower surface thereof and is coupled and fixed to the lower elastic member 160 (e.g., the second outer frame 162).

For example, the first coupling portion 143 of the housing 140 may be a protrusion, but in another embodiment, the first coupling portion may be a groove or a flat surface. For example, the second coupling portion 148 of the housing 140 may be a groove, but in other embodiments, it may be a protrusion or a flat surface.

For example, the first coupling portion 143 of the housing 140 and the hole 152a of the first outer frame 152 of the upper elastic member 150 may be coupled using heat fusion or adhesive, and the second coupling portion 148 of the housing 140 and the hole 162a of the second outer frame 162 of the lower elastic member 160 may be coupled using heat fusion or adhesive.

The housing 140 may include a seating portion for placing or seating the magnet 130. For example, the housing 140 may include a first seating portion 141a provided at one (e.g., the first side 141-1) of two side portions positioned opposite to each other for placing the first magnet unit 130-1 and a second seating portion 141b provided at the other one (e.g., 141-2) of the two side portions for placing the second magnet unit 130-2. For example, the housing 140 may include a third seating portion 141c provided at one (e.g., the fourth side 141-4) of the other two side portions thereof positioned opposite to each other for placing the third magnet 130-3 and a fourth seating portion 141d provided at the other one (e.g., 141-3) of the other two side portions for placing the dummy member 11.

Each of the first to third seating portions 141a to 141c of the housing 140 may be provided on an inner side surface of the corresponding one of the side portions of the housing 140, but is not limited thereto, and in another embodiment, it may be provided on an outer side surface of the corresponding one of the side portions of the housing 140.

Each of the first to third seating portions 141a to 141c of the housing 140 is formed as a groove having a shape that corresponds to or matches the corresponding one of the first to third magnets 130-1 to 130-3, but is not limited thereto.

For example, the first seating portion 141a (or the second seating portion 141b) of the housing 140 may have a first opening facing the first coil unit 120-1, and a second opening exposing a lower portion or a lower end of the first magnet unit 130-1. For example, the second seating portion 141b of the housing 140 may have a first opening facing the second coil unit 120-2, and a second opening exposing a lower portion or a lower end of the second magnet unit 130-2. Also, for example, the third seating portion 141c of the housing 140 has a first opening that opens toward the outer surface of the bobbin 110, and a second opening exposing a lower portion, a lower end of the third magnet unit 130-3. In another embodiment, each of the first to third seating portions of the housing 140 may include at least one of the first opening and the second opening.

For example, a side surface of at least one of the first to third magnet units 130-1 to 130-3 may be exposed from the outer side surface of the housing 140. For example, the first and second magnet units 130-1 and 130-2 may not be exposed to the outer side surface of the housing 140, but the third magnet unit 130-3 may be exposed to the outer side surface of the housing 140. As shown in FIG. 11, a width W2 of the third magnet unit 130-3 may be larger than a width of each of the first and second magnet units 130-1 and 130-2, and by exposing the third magnet 130-3 from the side portion of the housing 140 where the third magnet unit 130-3 is disposed, it is possible to avoid increasing the size of the housing 140.

The length W2 in a width direction of the third magnet unit 130-3 may be larger than a length W1 in the width direction of the first magnet unit 130-1 or/and a length in the width direction of the second magnet unit 130-2 (W2>W1).

In another embodiment, the first to third magnet units may not be exposed to the outer side surface of the housing 140.

The fourth seating portion 141d of the housing 140 may include at least one seating portion for mounting the dummy member 11. For example, the fourth seating portion 141d may include two seating portions on which the two dummy members 11A and 11B are disposed.

For example, a lower end or a lower surface of at least one of the first to third magnet units 130-1 to 130-4 and the dummy member 11 may protrude in a direction from the lower surface of the housing 140 toward the second circuit board 250.

At least a portion of the dummy member 11 fixed to or disposed on the seating portion 141d of the housing 140 may be exposed to an outside of the housing 140. For example, the lower end of the dummy member 11 may be exposed outside the seating portion 141d of the housing 140. For example, the lower end or the lower surface of the dummy member 11 may protrude from the lower surface of the housing 140 toward the second circuit board 250. For example, the first to third magnet units 130-1 to 130-3 and the dummy member 11 may be fixed to the seating portions 141a to 141d by an adhesive.

Support members 220-1 to 220-4 may be disposed at the corner portions 142-1 to 142-4 of the housing 140. The corner portions 142-1 to 142-4 of the housing 140 may include a hole 147 through which at least a portion of the support member 220-1 to 220-4 passes. In another embodiment, the support member may be disposed at the side portions of the housing 140.

For example, the housing 140 may include a hole 147 penetrating the upper portion of the corner portion 142-1 to 142-4.

At least one support member 220-1 to 220-4 may be disposed at at least one of the corner portions 142-1 to 142-4 of the housing 140. For example, at least one support member may be disposed at each of the corner portions 142-1 to 142-4 of the housing 140. For example, two support members 20A and 20B may be disposed at each of the corner portions 142-1 to 142-4 of the housing 140, and two holes 147A and 147B may be formed at each of the corner portions of the housing 140.

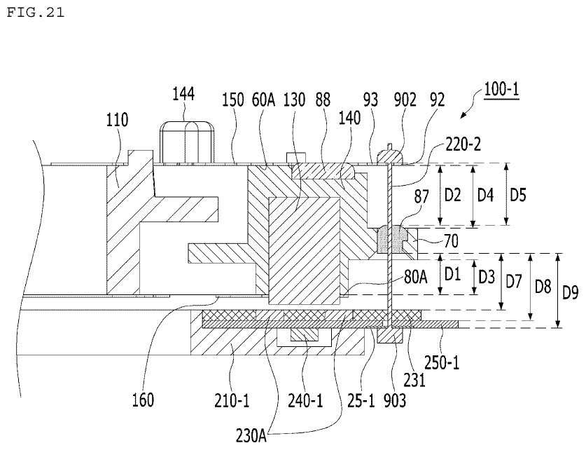

For example, the hole 147 may be a through hole that penetrates the housing 140 in the optical axis direction. For example, at least a portion of the support member 220 may pass through the hole 147 of the housing 140. One end of the support member 220 may be connected or bonded to the upper elastic member 150 by solder or conductive adhesive 902. For example, an edge of the one end of the support member 220 may protrude from solder 902 (see FIG. 21). In another embodiment, the end of the one end of the support member 220 may be located inside the solder 902 and may not protrude outside the solder 902.

For example, in order to easily apply the damper, a diameter of the hole 147 may gradually increase in a direction from the upper surface of the housing 140 to the lower surface of the housing 140, but it is not limited thereto, and in another embodiment, the diameter of the hole 147 may be uniform.

In another embodiment, the hole 147 of the housing 147 may include an opening that is partially open to the outside (or the outer side surface of the housing 140). In another embodiment, the housing 140 may include a groove or escape portion for the support member 220 to pass through instead of the hole 147. In another embodiment, the hole may be recessed from the outer side surface of the corner portion of the housing 140, and at least a portion of the hole may be open to the outer side surface of the corner portion. The number of holes 147 in the housing 140 may be equal to the number of support members.

The housing 140 may include at least one stopper 149 protruding from the outer side surface of the side portions 141-1 to 141-4, and the at least one stopper 149 may be configured to prevent the outer side surface of the housing 140 from directly colliding with the cover member 300 when the housing 140 moves in a direction perpendicular to the optical axis direction.

The housing 140 may include a groove 145 formed at a position corresponding to the protrusion 111 of the bobbin 110. For example, the groove 145 may be formed at the inner surface of at least one of the corner portions 142-1 to 142-4 of the housing 140. The groove portion 145 may be open at the top, and the groove portion 145 may have an opening formed at a side facing the outer surface of the corner portion of the bobbin 110.

The housing 140 may include a groove 14A (or a seating groove) for placing or receiving the circuit board 190. The housing 140 may include a groove 14B (or seating groove) for placing or receiving the first position sensor 170. The groove 14A of the housing 140 may be provided on any one (e.g., 141-3) of the side portions 141-1 to 141-4 of the housing 140. For example, to facilitate mounting of the circuit board 190, the groove 14A of the housing 140 may have an open at the top and an opening that opens to the inside of the housing 140. The groove 14B of the housing 140 may be provided on the inner side surface of the third side portion 143-2 of the housing 140, and may be connected or communicated with the groove 14A. For example, capacitor 175 may be disposed within the groove 14B of housing 140.

Referring to FIG. 5A, the housing 140 may include a protruding portion 70 that protrudes in a direction perpendicular to the optical axis from the outer side surface 62A of the corner portions 142-1 to 142-4. For example, the protruding portion 70 may be disposed at each corner portion of the housing 140. For example, the protruding portion 70 may be protruded in a direction (e.g., diagonal direction) perpendicular to the optical axis and toward the corner portion 142-1 to 142-4 of the housing 140 from the optical axis.

For example, when viewed in the optical axis direction or from the top, a shape of the protruding portion 70 may be polygonal, for example, trapezoidal. For example, when viewed in the optical axis direction or from the top, a horizontal length of the protruding portion 70 may decrease in the diagonal direction.

The protruding portion 70 may include a hole 147 through which at least a portion of the support member 220 passes. The hole 147 may be a through hole that penetrates the protruding portion 70 in the optical axis direction.

For example, the number of holes 147 may be equal to the number of support members 220 disposed at each corner portion of the housing 140. For example, the protruding portion 70 may include two holes 147A and 147B that are spaced apart from each other. In another embodiment, the protruding portion 70 may include one hole, and two support members may be arranged to be spaced apart from each other within the one hole.

For example, the protruding portion 70 may include a recess 65 for receiving the damper 87. For example, the recess 65 may be recessed from an upper surface 60B of the protruding portion 70. For example, the recess 65 may include a bottom surface 65A having a step from the upper surface 60B of the protruding portion 70 and a side surface 65B disposed between the bottom surface 65A and the upper surface 60B of the protruding portion 70 and connecting the bottom surface 65A and the upper surface 60B of the protruding portion 70.

For example, the hole 147 may be placed within the recess 65 of the protruding portion 70. For example, the hole 147 may be formed in the bottom surface 65A of the recess 65 of the protruding portion 70. For example, the hole 147 may penetrate the bottom surface 65A of the recess 65 of the protruding portion 70.

In another embodiment, the protruding portion 70 may not include the recess 65, and the damper 87 may be disposed on the upper surface 60B of the protruding portion 70.

The housing 140 may include a first surface 60A to which the upper elastic member 150 (e.g., the first outer frame 152 or the first coupling portion 91) contacts, attaches, or couples. For example, the first coupling portion 143 may be formed on the first surface 60A of the housing 140. For example, the first coupling portion 143 may protrude from the first surface 60A of the housing 140. For example, the stopper 144 may be formed on the first surface 60A of the housing 140. For example, the stopper 144 may protrude from the first surface 60A of the housing 140. For example, the first surface 60A may be positioned lower than an upper surface of the first coupling portion 113, an upper surface of the stopper 144, and an upper surface of the upper elastic member 150.

For example, the housing 140 may include a second surface 60B positioned lower than the first surface 60B. For example, the second surface may be the upper surface 60B of the protruding portion 70. Alternatively, in another embodiment, the second surface of the housing 140 may be the bottom surface 65A of the protruding portion 70.

For example, the first surface 60A and the second surface 60B of the housing 140 may be disposed or formed on corner portions 142-1 to 142-4 of the housing 140. For example, the first surface 60A of the housing 140 may have the same height as the upper surfaces of the side portions 141-1 to 141-4 of the housing 140. In another embodiment, the first surface 60A of the housing 140 may be positioned lower or higher than the upper surfaces of the side portions 141-1 to 141-4 of the housing 140.

For example, there may be a step in the optical axis direction between the first surface 60A and the second surface 60B. For example, the second surface 60B may be located below the first surface 60A. For example, the second surface 60B may be positioned lower than the first surface 60A. Additionally, the first surface 60A may be positioned closer to a center of the housing 140 or the optical axis OA than the second surface 60B. The second surface 60B may be located outside the first surface 60A.

The housing 140 may include a third surface 60C positioned lower than the first surface 60A and higher than the second surface 60B. For example, the third surface 60C may be disposed or formed on the corner portions 142-1 to 142-4 of the housing 140.

The third surface 60C may be located between the first surface 60A and the second surface 60B. For example, among the first to third surfaces 60A to 60C, the first surface 60A may be located closest to the center of the housing 140 or the optical axis, and the second surface 60B may be located furthest from the center of the housing 140 or the optical axis, and the third surface 60C may be located in the middle of the first surface 60A and the third surface 60B.

A damper 88 that contacts, attaches, or combines with the upper elastic member 150 (e.g., the first outer frame 152 or the connection portion 93) may be disposed on the third surface 60C. The housing 140 may include a protrusion 61 (or a guide protrusion) protruding from the third surface 60C. For example, the protrusion 61 may be disposed at an edge of the third surface 60C. For example, the protrusion 61 may serve to prevent the damper 88 from overflowing out of the outer side surface of the housing 140.

Referring to FIG. 5A, the housing 140 includes the first side surface 62A which is located between the second surface 60B and the third surface 60C and connects the second surface 60B and the protrusion 61. In an embodiment in which the protrusion 61 is omitted, the first side 62A of the housing 140 may connect the second side 60B and the third side 60C.

Referring to FIG. 5B, the protruding portion 70 may include a lower surface 60D that is opposite to the upper surface 60B. In addition, the housing 140 includes a second side surface 62B which is located between the lower surface 60D of the protruding portion and the lower surface 80A of the housing 140, and connects the lower surface 60D of the protruding portion 70 and the lower surface 80A of the housing 140. The first side surface 62A and the second side surface 62B of the housing 140 may have a step in the diagonal direction. The second side surface 62B may be located closer to the optical axis OA than the first side surface 62A.

Referring to FIG. 5B, the housing 140 may include a fourth surface 80A on which the lower elastic member 160 (e.g., the second outer frame 162) contacts, attaches, or couples. The fourth surface 80A may be located below the first surface 60A, the second surface 60B, and the third surface 60C of the housing 140.

For example, the upper surface of the housing 140 may include the first surface 60A and the second surface 60B of the housing 140. Or, for example, the lower surface of the housing 140 may include the fourth surface 80A of the housing 140. In another embodiment, the third surface 60C of the housing 140 may be omitted.

For example, the protruding portion 70 may overlap the second coupling portion 92 of the upper elastic member 150 in the optical axis direction or the first direction. For example, the protruding portion 70 may overlap at least a portion of the connection portion 93 of the upper elastic member 150 in the optical axis direction or the first direction.

The magnet 130 may be disposed at or coupled to the housing 140.

The magnet 130 may include a plurality of magnet units.

For example, the magnet 130 may include a first magnet unit 130-1, a second magnet unit 130-2, and a third magnet unit 130-3 disposed to be spaced apart from each other on the housing 140. For example, each of the first to third magnet units 130-1 to 130-3 may be disposed between the bobbin 110 and the housing 140.

For example, the first magnet unit 130-1, the second magnet unit 130-2, and the third magnet unit 130-3 may be disposed on the side portion of the housing 140. For example, the first magnet unit 130-1 and the second magnet unit 130-2 are disposed on two side portions 141-1 and 141-2 of the side portions 141-1 to 141-4 of the housing 140 which are opposite to each other. For example, the third magnet unit 130-3 may be disposed on one side portion of the housing 140 where the first and second magnet units 130-1 and 130-2 are not disposed. For example, the third magnet unit 130-3 may be disposed on the fourth side portion 141-4 of the housing 140.

Since the first and second coil units 120-1 and 120-2 for AF driving are disposed on two side portions of the bobbin 110 facing each other, any coil unit for AF driving may not be disposed between the bobbin 110 and the third magnet unit 130-3. Additionally, any coil unit for AF driving may not be disposed between the bobbin 110 and the dummy member 11.

In addition, for OIS driving, the first to third coil units 230-1 to 230-3 of the second coil 230 and the first to third magnet units of the magnet 130 may correspond to, face, or overlap each other, and the second coil 230 may not be disposed between the dummy member 11 and the base 210.

In another embodiment, the first magnet unit and the second magnet unit may be disposed on two corner portions of the housing 140 which are opposite to each other, and the third magnet unit may be disposed on one of two another corner portions of the housing 140 which are opposite to each other, and the dummy member may be disposed on the other one of the two another corner portions.

Another embodiment may include a magnet installation member. The magnet installation member may be provided separately from the housing 140, but is not limited thereto, and may be formed integrally with the housing 140 in other embodiments.

For example, the magnet installation member may be in the form of a frame, the frame may be coupled to the housing 140, and the magnet 130 may be installed or coupled to the frame.

At the initial position of the AF movable unit, the magnet 130 is disposed on the housing 140 so that at least a portion of the magnet 130 overlaps the first coil 120 in a direction parallel to a straight line which is perpendicular to the optical axis OA and passes through the optical axis OA.

The shape of each of the first to third magnet units 130-1 to 130-3 may be a polyhedron (e.g., hexahedron). For example, the cross-sectional shape of each of the first to third magnet units in a direction perpendicular to the optical axis may be polygonal, for example, triangle, square, pentagon, rhombus, or trapezoid, but is not limited thereto.

Each of the first to third magnet units 130-1 to 130-3 may be a unipolar magnetization magnet, but is not limited thereto. In another embodiment, each of the first to third magnet units 130-1 to 130-3 may be a bipolar magnetization magnet or a quadrupole magnet including two N poles and two S poles.

For example, the sensing magnet 180 may not overlap the first coil 120 in the optical axis direction. In another embodiment, the sensing magnet may overlap the first coil 120 in the optical axis direction.

The dummy member 11 may be disposed on the housing 140 to correspond to or face the third magnet unit 130-3. The dummy member 11 may be alternatively expressed as “weight balancing member”, “balancing member”, “weight compensation member” or “weight member”.

For example, the dummy member 11 may be disposed on the third side portion 141-3 of the housing 140.

The dummy member 11 may be made of a material that is not affected by magnets, may be made of a non-magnetic material, or may be a non-magnetic body, but is not limited thereto. In another embodiment, the dummy member 11 may be a magnetic material or may include a magnetic body.

The dummy member 11 is used to balance the weight of the three magnet units 130-1 to 130-4 disposed on the housing 140.

For example, the dummy member 11 may have the same mass as the third magnet unit 130-3. In another embodiment, the weight of the dummy member 11 may have an error with the weight of the third magnet unit 130-3 within a range that does not cause an error in the OIS operation due to weight imbalance.

The dummy member 11 may include at least one dummy 11A and 11B. For example, the dummy member 11 may include one dummy or two or more dummies. For example, the dummy member 11 may include a first dummy 11A and a second dummy 11B that are spaced apart from each other.

For example, at least a portion of the protrusion 111 of the bobbin 110 may be disposed between the first and second dummies 11A and 11B. Or, for example, at least a portion of the sensing magnet 180 may be disposed between the first and second dummies 11A and 11B.

For example, the first dummy 11A and the second dummy 11B may have symmetrical shapes or the same shape, and may be arranged symmetrically with respect to the sensing magnet 180. In another embodiment, the first dummy 11A and the second dummy 11B may be arranged asymmetrically with respect to the sensing magnet 180.

At least a portion of the dummy member 11 may overlap the third magnet unit 130-3 in a direction which is perpendicular to the optical axis and from the third corner portion 142-3 of the housing 140 to the fourth corner portion 142-4 of the housing 140.

For example, the dummy member 11 may not overlap the second coil 230 in the optical axis direction. Since the dummy member 11 does not affect OIS driving, the lens driving device may not include a coil unit corresponding to the dummy member.

For example, when the dummy member 11 includes a magnetic material, a magnetic strength of the dummy member 11 may be smaller than a magnetic strength of the third magnet unit 130-3. For example, the dummy member 11 may include tungsten, and tungsten may account for 95% or more of the total weight, but is not limited thereto. For example, the dummy member 11 may be a tungsten alloy.

For example, the dummy member 11 may have a polyhedral shape, for example, a rectangular parallelepiped. In other embodiments, it may be formed in various shapes capable of weight compensation. For example, the dummy member 11 may include rounded portions or curved surfaces at the side edges thereof.

The housing 140 may include the groove 14B to avoid spatial interference with the sensing magnet 180, the protruding portion 116 of the bobbin 110 and the first position sensor 170. For example, the groove 14B may be formed on the inner surface of the third side portion 141-3 of the housing 140. Additionally, the groove 14B may be located between the first and second dummies 11A and 11B.

FIGS. 11 to 13, for example, each of the first magnet unit 130-1 and the second magnet unit 130-2 includes a first magnet portion 33A, a second magnet portion 33B, and a partition wall 33C disposed between the first magnet portion 33A and the second magnet portion 33B. Here, the partition wall 33C may be alternatively expressed as a “non-magnetic barrier wall.” The partition wall 33C is configured to separate or isolate the first magnet portion 33A and the second magnet portion 33B, and may be a portion that is substantially non-magnetic and has little polarity. For example, the partition wall 33C may be made of a non-magnetic material, air, or the like. The non-magnetic partition wall may be expressed as a “Neutral Zone” or “Neutral region”.

For example, the second magnet unit 130-2 may have the same structure as the first t magnet unit 130-1, and the description of the first magnet unit 130-1 can be applied or applied by analogy to the second magnet unit 130-2. In another embodiment, each of the first magnet unit 130-1 and the second magnet unit 130-2 may be a unipolar magnetized magnet including one N pole and one S pole.

The third magnet unit 130-3 may be a unipolar magnetized magnet including one N pole and one S pole. In another embodiment, the third magnet unit 130-3 may be a bipolar magnetized magnet including a first magnet portion, a second magnet portion, and a partition wall disposed between the first magnet portion and the second magnet portion.

When viewed from the top side, the first magnet unit 130-1 may be located inside an area of the first coil unit 230-1 and may overlap the first coil unit 230-1 in the optical axis direction.

When viewed from the top side, the second magnet unit 130-2 may be located inside an area of the second coil unit 230-2 and may overlap the second coil unit 230-2 in the optical axis direction.

When viewed from the top side, the third magnet unit 130-3 may be located inside an area of the third coil unit 230-3 and may overlap the third coil unit 230-3 in the optical axis direction.

For example, the first magnet unit 130-1 and the second magnet unit 130-2 may have the same length, width, and height. In another embodiment, the first magnet unit 130-1 and the second magnet unit 130-2 may have different lengths, widths, or heights.

Also, for example, the first coil unit 230-1 and the second coil unit 230-2 may have the same length, width, and height. In another embodiment, the first coil unit 230-1 and the second coil unit 230-2 may have different lengths, widths, or heights. For example, in each configuration 130, 230, and 11, the width may be shorter than the length. Additionally, the width of each component (130, 230, and 11) may alternatively be expressed as “thickness” of each component 130-1 to 130-3, and 135. Also, for example, the heights H1, H2, and H3 of each configuration 130, 230, and 11 may be the length in the optical axis direction of each configuration.

The heights of the first to third coil units 230-1 to 230-3 may be equal. In another embodiment, at least one of the heights of the first to third coil units 230-1 to 230-3 may be different from the rest of them. For example, the height T11 of the first coil unit 230-1 may be equal to the height of the second coil unit 230-2, and the height T12 of the third coil unit 230-3 may be greater than the height T11 of the first coil unit 230-1 (T12>T11). In another embodiment, the height T12 of the third coil unit 230-3 may be smaller than the height T11 of the first coil unit 230-1.

For example, the length L1, L2 in the longitudinal direction of each of the magnet units 130-1, 130-2, and 130-3 may be smaller than the length M1, M2 in the longitudinal direction of each coil unit 230-1, 230-2, and 230-3 corresponding to each magnet unit (L1<M1, L2<M2). In another embodiment, L1 and M1 may be equal to each other, and L2 and M2 may be equal to each other.

For example, the length W1, W2 in the width direction of each of the magnet units 130-1, 130-2, and 130-3 may be smaller than the length in the width direction of each coil unit 230-1, 230-2, and 230-3 corresponding to each magnet unit (W1<K1, W2<K2). In another embodiment, W1 and K2 may be equal to each other, and W2 and K2 may be equal to each other.

For example, the length M2 in the longitudinal direction of the third coil unit 230-3 may longer than the length M1 in the longitudinal direction of the first coil unit 230-1 or/and the length of the second coil unit 230-2 (M2>M1). Also, for example, the length L2 in the longitudinal direction of the third magnet unit 130-3 may be larger than the length L1 in the longitudinal direction of the first magnet unit 130-1 or/and the length in the longitudinal direction of the second magnet unit 130-2 (L2>L1).

Since M2>M1 and L2>L1, the first electromagnetic force generated by the third coil unit 230-3 and the third magnet unit 130-3 may be greater than the second electromagnetic force generated by the first coil unit 230-1 and the first magnet 130-1 and the third electromagnetic force generated by the second coil unit 230-2 and the second magnet unit 130-2. Because of this, in the embodiment the difference between the first electromagnetic force in the X-axis direction and the sum of the second and third electromagnetic forces in the Y-axis direction can be reduced, and the reliability of the OIS operation can be improved.

In another embodiment, M2 and M1 may be equal to each other. Additionally, in another embodiment, L2 and L1 may be equal to each other.

Also, for example, the length K2 in the width direction of the third coil unit 230-3 may be larger than the length K1 in the width direction of the first coil unit 230-1 or/and length in the width direction of the second coil unit 230-2 (K2>K1). In another embodiment, K2 and K1 may be equal to each other.

For example, the length W2 in the width direction of the third magnet unit 130-3 may be larger than the length W1 in the width direction of the first magnet unit 130-1 or/and the length in the width direction of the second magnet unit 130-2 (W2>W1). Since W2>W1, in the embodiment the difference between the first electromagnetic force in the X-axis direction and the sum of the second and third electromagnetic forces in the Y-axis direction can be reduced and the reliability of OIS operation can be improved. In another embodiment, W1 and W2 may be equal to each other.

For example, the third magnet unit 130-3 may include a portion whose width decreases from the lower surface of third magnet unit 130-3.

For example, the height H2 of the third magnet unit 130-3 may be smaller than the height H1 of the first magnet unit 130-1 and/or the height of the second magnet unit 130-2 (H2<H1). For example, the length in the optical axis direction of the first magnet unit 130-1 may be equal to the length in the optical axis direction of the second magnet unit 130-2. Since H2<H1, in the embodiment the weight of the lens driving device can be reduced and power consumption for AF driving or/and OIS driving can be reduced. In another embodiment, H2 and H1 may be equal to each other.

For example, the length L32 and L33 in the longitudinal direction of the dummy member 11 may be smaller than the length L2 in the longitudinal direction of the third magnet unit 130-3. For example, the length W31 in the width direction of the dummy member 11 may be smaller than the length W2 in the width direction of the third magnet unit 130-3 (W31<W2).

For example, the length L32 of the first dummy 11A and the length L33 of the second dummy 11B may be equal to each other, but are not limited thereto, and in other embodiments, both may be different from each other. In addition, the length in the width direction of the first dummy 11A and the length in the width direction of the second dummy 11B may be equal to each other, but are not limited thereto, and in other embodiments, both may be different from each other.

Since W31<W2, in the embodiment sufficient space (e.g., groove 14B of the housing 140) to avoid spatial interference with the protruding portion 116 of the bobbin 110 can be secured, and spatial interference between the protruding portion 116 (or the sensing magnet 180) and the dummy member 11 can be prevented. In another embodiment, W31 and W2 may equal to each other.

Additionally, a first separation distance in the optical axis direction between the first magnet unit 130-1 and the first coil unit 230-1, and a second separation distance between the second magnet unit 130-2 and the second coil unit 230-2, and a third separation distance in the optical axis direction between the third magnet unit 130-3 and the third coil unit 230-3 may be equal to each other.

In other embodiments, the third separation distance may be smaller than the first separation distance and/or the second separation distance. And because the third separation distance is smaller than the first separation distance and/or the second separation distance, compared to the case where the first to third separation distances are equal to each other, in another embodiment, the difference between the electromagnetic force generated in the X-axis direction and electromagnetic force generated in the Y-axis can be further reduced.

For example, the height H3 of the dummy member 11 may be less than or equal to the height H2 of the third magnet unit 130-3. In another embodiment, the height H3 of the dummy member 11 may be greater than the height H2 of the third magnet unit 130-3.

For example, the number of turns of the first coil unit 230-1 of the second coil 230 may be the equal to the number of turns of the second coil unit 230-1. In another embodiment, the number of turns of the first coil unit 230-1 and the number of turns of the second coil unit 230-2 may be different.

Also, for example, the number of turns of the first coil unit 230-1 may be smaller than the number of turns of the third coil unit 230-2. The number of turns of the second coil unit 230-2 may be smaller than the number of turns of the third coil unit 230-2.

For example, the sum of the number of turns of the first coil unit 230-1 and the number of turns of the second coil unit 230-2 may be greater than the number of turns of the third coil unit 230-3. Here, the number of turns may be the total number of turns of the coil rotated or wound in a ring shape. In another embodiment, the sum of the number of turns of the first coil unit 230-1 and the number of turns of the second coil unit 230-2 may be equal to or smaller than the number of turns of the third coil unit 230-3.

For example, the width of single strand of the first coil unit 230-1 may be the equal to the width of single strand of the second coil unit 230-2.

For example, the width of single strand of the third coil unit 230-3 may be smaller than the width of single strand of the first coil unit 230-1 (or the second coil unit 230-2). In another embodiment, the width of single strand of the third coil unit 230-3 may be the equal to the width of single strand of the first coil unit 230-1 (or the second coil unit 230-2). In another embodiment, the width of single strand of the third coil unit 230-3 may be larger than the width of single strand of the first coil unit 230-1 (or the second coil unit 230-2).

The embodiment may include the three magnet units 130-1 to 130-3 and three OIS coils corresponding to the three magnet units 130-1 to 130-3 in order to reduce magnetic field interference between magnet units in adjacent lens driving devices in a dual or more camera device.

Among the three magnet units 130-1 to 130-3, two magnet units 130-1 and 130-2 are configured to perform AF operation that moves the bobbin 110 by an interaction with the first and second coil units 120-1 and 130-2 of the first coil 120, and perform OIS operation for moving the housing 140 in one of the X-axis direction and the Y-axis direction by an interaction with the first and second coil units 230-1 and 230-2 of the second coil 230. In addition, among the three magnet units 130-1 to 130-3, the remaining magnet unit 130-3 is configured to perform OIS operation for moving the housing 140 in the other of the Y-axis directions and the Y-axis direction.

Since each of the first and second magnet units 130-1 and 130-2 is composed of a four-pole magnet, in the embodiment, the electromagnetic force with a corresponding one of the first and second coil units 230-1 and 230-2 can be improved, and thus the current consumption required to OIS driving can be reduced.

Additionally, by disposing the dummy member 11 at the opposite side of the third magnet unit 130-3, in the embodiment, oscillation due to weight eccentricity during OIS operation can be prevented.

Generally, the first electromagnetic force by an interaction between single magnet unit and single OIS coil unit is smaller than the second electromagnetic force by an interaction between two magnet units and two OIS coil units, and difference between the first and second electromagnetic forces may cause malfunction of the OIS driving.

The number of turns of the third coil unit 230-3 (hereinafter “the first number of turns”) may be greater than the number of turns of the first coil unit 230-1 (hereinafter “the second number of turns”) or/and the number of turns of the second coil unit 230-2 (hereinafter referred to as the “third number of turns”), thereby the difference between the electromagnetic force generated in the X-axis direction and the electromagnetic force generated in the Y-axis direction can be reduced.

Additionally, the length L2 of the third magnet unit 130-3 may be greater than the length L1 of the first magnet unit 130-1 and/or the length of the second magnet unit 130-2, and the length M2 of the three coil unit 230-3 may be greater than the length M1 of the first coil unit 230-1 and/or the length of the second coil unit 230-2. Because of this, in the embodiment, the difference between the electromagnetic force generated in the X-axis direction and the electromagnetic force generated in the Y-axis direction can be reduced.

In another embodiment, the third magnet unit 130-3 and the dummy member 11 may be omitted. Another embodiment may include a ring-shaped first coil surrounding the outer surface of the bobbin 110 around the optical axis instead of the first coil 120.

In another embodiment, the third magnet unit 130-3 and the dummy member 11 may be omitted, and a third magnet unit and a fourth magnet unit may be provided instead of the omitted third magnet unit 130-3 and the dummy member 11. At this this time, each of the third and fourth magnet units may have the same or similar structure as the first magnet unit 130-1. In another embodiment, a magnet unit corresponding to or facing the first coil may be provided on at least one of the corner portions (e.g., each corner portion) of the housing 140.

In another embodiment, instead of the three magnet units 130-1 to 130-3 and the dummy member 11, the driving magnet for AF operation may include four magnet units disposed on the side portions or corner portions of the housing 140. In another embodiment, the AF driving magnet may include two magnet units disposed on two side portions or two corner portions of the housing 140. In another embodiment, the coil 120 may be disposed at the housing 140, and the magnet 130 may be disposed at the bobbin 110.

Next, the first position sensor 170, the first circuit board 190, and the capacitor 175 will be described.

Referring to FIGS. 2 and 4A, the first circuit board 190 may be disposed on or coupled to the housing 140. For example, the first circuit board 190 may be disposed on one side portion 141-3 of the housing 140. In another embodiment, the first circuit board 190 may be disposed on one corner portion of the housing 140. For example, the first circuit board 190 may be disposed in the groove 14A of the housing 140. For example, the first circuit board 190 may be disposed between two corner portions 142-2 and 142-3 of the housing 140. The first circuit board 190 may include terminals 3A to 3F that are conductively connected to the first position sensor 170.

For example, the terminals 3A to 3F may be disposed on at least one of the first and second surfaces of the first circuit board 190. For example, the first surface of the circuit board 190 may be one surface of the first circuit board 190 facing the bobbin 110. And the second surface of the first circuit board 190 may be an opposite surface of the first surface of the first circuit board 190. For example, the first to fourth terminals 3A to 3D may be disposed on the second surface of the first circuit board 190, and the fifth and sixth terminals 3E and 3F may be disposed on the first surface of the first circuit board 190. For example, the first circuit board 190 may be a printed circuit board or FPCB.

The first position sensor 170 may be disposed at the housing 140. For example, the first position sensor 170 may be disposed on or coupled to one side portion (e.g., 141-3) of the housing 140. For example, in another embodiment, the first position sensor 170 may be disposed on one corner portion of the housing 140.

In another embodiment, the positions of the sensing magnet 180 and the first position sensor 170 may be arranged opposite to each other. For example, the sensing magnet may be disposed at the housing, and the first position sensor 170 may be disposed at the bobbin 110. In this case, the first circuit board may be disposed on the bobbin 110 together with the first position sensor, and instead of the first circuit board, a conductive pattern conductively connecting the first position sensor and the upper elastic member 150 may be directly formed on the bobbin 110.

For example, the first position sensor 170 may be disposed or mounted on the first circuit board 190. For example, the first position sensor 170 may be disposed or mounted on the first surface of the first circuit board 190.

The first position sensor 170 may detect the sensing magnet 180 disposed at the bobbin 110 according to the movement of the bobbin 110. For example, the first position sensor 170 can detect the strength of the magnetic field of the sensing magnet 180 and output an output signal according to the detected result.

For example, the first position sensor 170 may include a Hall sensor and a driver. For example, the Hall sensor of the first position sensor 170 may output an output signal (e.g., output voltage) according to the result of detecting the strength of the magnetic force of the sensing magnet 180. For example, the magnitude of the output signal of the first position sensor 170 may be proportional to the strength of the detected magnetic force of the sensing magnet 180. For example, the driver of the first position sensor 170 may output a driving signal for driving the Hall sensor and a driving signal for driving the first coil 120.

In addition, for example, the driver of the first position sensor 170 can receive a clock signal, a data signal, and a power signal from the controller 830 or 780 using data communication using a protocol, for example, I2C communication. For example, the power signal may include a first power signal and a second power signal. For example, the first power signal may be ground voltage or 0 [V]. The second power signal may be a preset voltage for driving the driver, and may be a direct current voltage or/and an alternating current voltage.

The first position sensor 170 includes a first terminal for a clock signal, a second terminal for a data signal, third and fourth terminals for the power signal, and fifth and sixth terminals for supplying a drive signal to the first coil 120.

The first position sensor 170 may be conductively connected to the first circuit board 190. For example, each of the first to fourth terminals of the first position sensor 170 may be conductively connected to a corresponding one of the first to fourth terminals 3A to 3D of the first circuit board 190.

The first coil 120 may be conductively connected to the first circuit board 190 and the first position sensor 170. For example, each of the fifth and sixth terminals of the first position sensor 170 may be conductively connected to a corresponding one of the fifth and sixth terminals 3E and 3F of the first circuit board 190. For example, the fifth terminal 3E of the first circuit board 190 may be coupled to the fifth upper elastic member 150-5 by solder or a conductive adhesive member and may be conductively connected to the fifth upper elastic member 150-5. The sixth terminal 3F of the first circuit board 190 may be coupled to the sixth upper elastic member 150-6 by solder or a conductive adhesive member and may be conductively connected to the sixth upper elastic member 150-6.

The first circuit board 190 can supply a power signal to the first position sensor 170 through the first to fourth terminals 3A to 3D, and can transmit and receive clock signals and data signals. Additionally, the first circuit board 190 may supply a driving signal to the first coil 120 through the fifth and sixth terminals 3E to 3F.

The lens driving device 100 may include a capacitor 175 that is conductively connected to the first position sensor 170. For example, the capacitor 175 may be disposed or mounted on the first circuit board 190.

The capacitor 175 may be in the form of a chip, and in this case, the chip may include a first terminal which is one end of the capacitor 175 and a second terminal which is the other end of the capacitor 175. The capacitor 175 may also be alternatively expressed as a “capacitive element” or a condenser.

In another embodiment, the capacitor may be formed integrally with the first circuit board 190 so that it is included in the first circuit board 190. For example, the first circuit board 190 may include a capacitor including a first conductive layer, a second conductive layer, and an insulating layer (e.g., dielectric layer) disposed between the first conductive layer and the second conductive layer.

For example, the capacitor 175 may be connected in parallel to two terminals of the first position sensor 170 to which power is supplied. Or, for example, the capacitor 175 is connected in parallel to the third and fourth terminals (e.g., 3C, 3D) of the first circuit board 190 that are conductively connected to the two terminals of the first position sensor 170 to which power is supplied.

For example, one end of the capacitor 175 (or the first terminal of the capacitor chip) may be conductively connected to the third terminal 3C of the circuit board 190, and the other end of the capacitor 175 (or the second terminal of the capacitor chip) may be conductively connected to the fourth terminal 3D of the circuit board 190.

The capacitor 175 is conductively connected in parallel to the third and fourth terminals 3C and 3D of the first circuit board 190. The capacitor 175 may serve as a smoothing circuit that removes the ripple included in the power signal supplied to the first position sensor 170 from the outside. Thus a stable and uniform power signal can be supplied to the first position sensor 170.

The capacitor 175 is conductively connected in parallel to the third and fourth terminals 3C and 3D of the circuit board 190. Thereby the first position sensor 170 can be protected from noise of high frequency components coming from the outside or ESD (electrostatic discharge).

Referring to FIGS. 6A and 6B, the lens driving device 100 may include an elastic member coupled to at least one of the bobbin 110 and the housing 140. The elastic member may elastically support the bobbin 110 with respect to the fixing unit (e.g., housing 140). For example, the elastic member may include at least one of the upper elastic member 150 and the lower elastic member 160.

For example, the upper elastic member 150 may be coupled with the bobbin 110 and the housing 140. For example, the upper elastic member 150 may be coupled to an upper portion, an upper surface, or an upper end of the bobbin 110 and an upper portion, an upper surface, or an upper end of the housing 140. For example, the lower elastic member 160 may be coupled with the bobbin 110 and the housing 140. For example, the lower elastic member 160 may be coupled to a lower portion, a lower surface, or a lower end of the bobbin 110 and a lower portion, a lower surface, or a lower end of the housing 140.

The upper elastic member 150 may include a plurality of upper elastic members. For example, the upper elastic member 150 may include a plurality of upper elastic members 150-1 to 150-7 that are conductively separated from each other. For example, the plurality of upper elastic members 150-1 to 150-7 may be disposed to be spaced apart from each other.

FIG. 6a shows seven conductively separated upper elastic members, but the number is not limited thereto, and in another embodiment, the upper elastic member may include one or two or more upper elastic members.

At least one of the first to seventh upper elastic members 150-1 to 150-7 may include a first inner frame 151 coupled to the bobbin 110. At least one of the first to seventh upper elastic members 150-1 to 150-7 may include a first outer frame 152 coupled to the housing 140. At least one of the first to seventh upper elastic members 150-1 to 150-7 may include a first frame connection portion 153 connecting the first inner frame 151 and the first outer frame 152. The elastic member may be alternatively expressed as a “spring” or an “elastic unit,” the inner frame may be expressed as an “inner portion,” the outer frame may be expressed as an “outer portion,” and the frame connection may be expressed as “connection portion” instead.

For example, the first inner frame 151 of the upper elastic member 150 may include a hole 151a for coupling to the first coupling portion 113 of the bobbin 110. For example, the first outer frame 152 of the upper elastic member 150 may include a hole 152a for coupling to the first coupling portion 143 of the housing 140.

For example, at least one of the hole 151a of the first inner frame 151 and the hole 152a of the second outer frame 152 may include at least one slit which an adhesive member enters into a space between the first coupling portions 113 and 143 and the holes 151a and 152a.

For example, the first outer frame 152 includes a first coupling portion 91 coupled to the housing 140, a second coupling portion 92 coupled to the support member 220, and a connection portion 93 connecting the first coupling portion 91 and the second coupling portion 92.

The first coupling portion 91 may include at least one coupling region coupled to the housing 140 (e.g., corner portions 142-1 to 142-4). For example, the coupling region of the first coupling portion 91 may include at least one hole 152a coupled to the first coupling portion 143 of the housing 140.

For example, the coupling region may have one or more holes, and one or more first coupling parts may be provided in the corner portions 142-1 to 142-4 of the housing 140 corresponding to the coupling region. In the embodiment of FIG. 6A, the coupling region of the first coupling portion 91 is implemented to include a hole 152a, but in other embodiments, the coupling region has various shapes sufficient to couple with the housing 140, for example, a groove shape, etc.

The second coupling portion 92 may be coupled to one end of the support member 220. For example, the second coupling portion 92 may have a hole 92A through which the support member 220 passes. The one end of the support member 220 that passes through the hole 92A may be directly coupled to the second coupling portion 92 by a conductive adhesive member or solder 902 (see FIG. 7A), and the second coupling portion 92 and the support member 220 may be conductively connected to each other. For example, the second coupling portion 92 is an region where the solder 902 is disposed for coupling to the support member 220, and may include the hole 92A and an region around the hole 92A.

In an embodiment in which two support members are disposed at one corner of the housing 140, the first outer frame 151 may include two second coupling portions 92-1 and 92-2. For example, the second coupling portion 92 may include a second-first coupling portion 92-1 coupled to one of the two support members, and a second-second coupling portion 92-2 coupled to the other one of the two support members.

The connection portion 93 may connect the first coupling portion 91 and the second coupling portion 92. For example, the connection portion 93 may connect the coupling region of the second coupling portion 92 and the first coupling portion 91.

For example, the connection portion 93 is a first connection portion connecting the first coupling portion 91 and the second-first coupling portion 92-1 and a second connection portion connecting the first coupling portion 91 and the second-second coupling portion 92-2. The connection portion 93 may include a bent portion that is bent at least once or a curved portion that is bent at least once. In another embodiment, the connection portion may have a straight shape.

For example, the first coupling portion 91 may contact the upper surface (e.g., first surface 60A) of the corner portions 142-1 to 142-4 of the housing 140, and may be supported by corner portions 142-1 to 142-4. For example, the second coupling portion 92 is not supported by the housing 140 and may be spaced apart from the housing 140.

The lens driving device 100 may include a damper 88 disposed in an empty space between the connection portion 93 and the housing 140 to prevent oscillation due to vibration. For example, the damper 88 may be in contact with, attached to, or coupled to at least a portion of the housing 140 (e.g., third surface 60C) and the connection portion 93.

The upper elastic member 150 may include at least one first outer frame 152 coupled to at least one of the plurality of corner portions 142-1 to 142-4 of the housing 140.

For example, at least one of the plurality of upper elastic members may be disposed at the plurality of corner portions 142-1 to 142-4 of the housing 140.

For example, the first to sixth upper elastic members 150-1 to 150-6 may include a first outer frame 152 disposed at the corner portions 142-1 to 142-4 of the housing 140.

In FIG. 6A, an outer frame of single upper elastic member may be disposed at at least one of the corner portions of the housing 140, and outer frames of two upper elastic members may be disposed at at least another one of the corner portions of the housing 140. In another embodiment, an outer frame of single upper elastic member may be disposed at each corner portion of the housing 140. In another embodiment, outer frames of two upper elastic members may be disposed at each corner portion of the housing 140.

For example, each of the first to fourth upper elastic members 150-1 to 150-4 may be coupled to and conductively connected to a corresponding one of the first to fourth terminals 3A to 3D of the first circuit board 190 by solder or conductive adhesive.

For example, each of the first to fourth upper elastic members 150-1 to 150-4 may include extension portion P1 to P4 extending to a corresponding one of the first to fourth terminals 3A to 3D of the first circuit board 190.

The extension portions P1 to P4 of the first to fourth upper elastic members 150-1 to 150-4 may be coupled to and conductively connected to a corresponding one of the first to fourth terminals 3A to 3D of the first circuit board 190 by solder or conductive adhesive. For example, each of the extension portion P1 to P4 may extend toward a corresponding one of the first to fourth terminals 3A to 3D of the first circuit board 190 from a portion of the first outer frame 152 of a corresponding one of the first to fourth upper elastic members 150-1 to 150-4. For example, the extension portions P1 to P4 may extend from the first coupling portion 91 of the first to fourth upper elastic members 150-1 to 150-4.

In the embodiment of FIG. 2, the four upper elastic members 150-1 to 150-4 (or the second coupling portion 92 and the connection portion 93) to which are connected to the first to fourth terminals 3A to 3D of the first circuit board 190 to which are connected to the first to fourth terminals of the first position sensor 170 may be disposed at two corner portions of the housing 140. In another embodiment, each of four upper elastic members 150-1 to 150-2 (or the second coupling portion 92 and the connection portion 93) to which are connected to the first to fourth terminals 3A to 3D of the first circuit board 190 may be disposed at a corresponding one of the four corner portions of the housing 140.

The first coil 120 may be conductively connected to the first circuit board 190 and/or the first position sensor 170 by at least one of the upper elastic member 150 and the lower elastic member. For example, the first coil 120 may be conductively connected to the fifth and sixth terminals 3E and 3F of the first circuit board 190 through the fifth and seventh upper elastic members 150-5 to 150-7.

For example, the fifth upper elastic member 150-5 may include a first bonding portion 41 to which one end of the first coil unit 120-1 is coupled and the first bonding portion 41 may be formed at one end of the first inner frame 151 thereof. For example, the sixth upper elastic member 150-6 may include a second bonding portion 42 to which one end of the second coil unit 120-2 and the second bonding portion 42 may be formed at one end of the first inner frame 151 thereof.

The seventh upper elastic member 150-7 may include a third bonding portion 43 to which the other end of the first coil unit 120-1 is coupled and third bonding portion 43 may be formed at one end of the first inner frame 151 of the seventh upper elastic member 150-7. The seventh upper elastic member 150-7 may include a fourth bonding portion 44 to which the other end of the second coil unit 120-2 and the fourth bonding portion 44 may be formed at the other end of the first inner frame 151 of the upper elastic member 150-7. A groove for guiding one end and the other end of the first coil 120 may be formed at each bonding portion 41 to 44. Each bonding portion 41 to 44 and the first coil 120 may be coupled to and conductively connected to each other by solder or a conductive adhesive 901 (see FIG. 2).

For the first to fourth bonding portions 41 to 44, the term “bonding portion” may be replaced with a pad portion, a connection terminal, a solder portion, or an electrode portion. The first coil unit 120-1 and the second coil unit 120-2 may be connected in series by the fifth to seventh upper elastic members 150-5 to 150-7.

For example, each of the fifth and sixth upper elastic members 150-5 to 150-6 is coupled to and conductively connected to a corresponding one of the fifth and sixth terminals 3E to 3F of the first circuit board 190 by solder or conductive adhesive.

For example, each of the fifth and sixth upper elastic members 150-5 and 150-6 may include the extension portion P5 and P6 extending to a corresponding one of the fifth and sixth terminals 3E and 3F of the first circuit board 190.

The extension portions P5 and P6 may be coupled to and conductively connected to the corresponding one of the fifth and sixth terminals 3E to 3F of the first circuit board 190 by solder or conductive adhesive. For example, each of the extension portions P5 or P6 may extend toward a corresponding one of the fifth and sixth terminals 3E and 3F of the first circuit board 190 from a portion of the first outer frame 152 of a corresponding one of the fifth and sixth upper elastic members 150-5 and 150-6. For example, the extension portions P5 and P6 may extend from the first coupling portion 91 of the fifth and sixth upper elastic members 150-6 and 150-6.

In an embodiment including a first coil wound around the optical axis on the outer peripheral surface of the bobbin 110, both ends of the first coil may be conductively connected to the first circuit board 190 by two upper elastic members. At this time, one end of the first coil may be conductively connected to one of the two upper elastic members, and the other end of the first coil may be conductively connected to the other one of the two upper elastic members, and the two upper elastic members may be conductively connected to the first circuit board 190.

The lower elastic member 160 may be comprised of a single spring or a single elastic unit, but is not limited thereto, and may include a plurality of springs or a plurality of elastic units spaced apart from each other in another embodiment.

The lower elastic member 160 may include a second inner frame 161 coupled or fixed to the lower portion, lower surface, or lower end of the bobbin 110, a second outer frame 161 coupled or fixed to the lower portion, lower surface, or lower end of the housing 140, and a second frame connection portion 163 that connects the second inner frame 161 and the second outer frame 162.

In another embodiment, the first coil 120 may be conductively connected to the first circuit board 190 and the first position sensor 170 by three lower elastic members instead of the three upper elastic members 150-5 to 150-7, and a driving signal may be supplied to the first coil.

In another embodiment, the first coil may be conductively connected to the two lower elastic members, and may be conductively connected to the first circuit board and the first position sensor through the two upper elastic members, and a driving signal may be supplied to the first coil through the two lower elastic members.

Each of the first frame connection portion 153 of the upper elastic member 150 and the second frame connection portion 163 of the lower elastic member 160 may be formed to be bent or curved at least once so as to form a pattern having a certain shape. The bobbin 110 may be elastically supported through a change in position and slight deformation of the connection portion 72 and the first and second frame connection portions 153 and 163, when the bobbin 110 moves upward and/or downward in the first direction.

The second inner frame 161 may include a hole 161a for coupling with the second coupling portion 117 of the bobbin 110, and the second outer frame 162 may include a hole 162a for coupling with the second coupling portion 148 of the housing 140.

The upper elastic member 150 and the lower elastic member 160 may be embodied as a leaf springs, but in other embodiments, they may be implemented as coil springs, etc. Additionally, the upper elastic member 150 and the lower elastic member 160 may include a conductive material, for example, a conductive metal.

In order to absorb and buffer the vibration of the bobbin 110, the lens driving device 100 may include a damper 85 (see FIG. 2) disposed between the upper elastic member 150 and the bobbin 110. For example, the damper 85 may be disposed between the bobbin 110 and the first frame connection portion 153 of the upper elastic member 150, and may be in contact with, coupled with, or attached to both of the bobbin 110 and the first frame connection portion 153.

For example, the bobbin 110 may include a protrusion 115 that corresponds to the first frame connection portion 153 of the upper elastic member 150 and protrudes from the upper surface of the bobbin 110. For example, a recess for accommodating the damper 85 may be formed at the protrusion 115. Additionally, the first frame connection portion 153 may include a protruding portion 53A that protrudes in a direction perpendicular to the optical axis. The protruding portion 53A may protrude toward the protrusion 115 of the bobbin 110. For example, a hole 53B may be formed at the protruding portion 54A to increase a contact area with the damper 85. At least a portion of the damper 85 may be disposed within the hole 53B. For example, the damper 85 may be in contact with, attached to, or coupled to at least one of the protrusion 115 and the protruding portion 54A. For example, at least a portion of the damper 85 may be in contact with, attached to, or coupled to the recess of the protrusion 115, and at least another portion of the damper 85 may be in contact with, attached to, or coupled to the protruding portion 54A. For example, the above-described dampers 85, 87, and 88 may be made of a material different from the contact portion and may be made of a vibration absorbing material. For example, the vibration absorbing material may include at least one of epoxy, silicone, thermosetting adhesive, or photocurable adhesive.

For example, the lens driving device 110 may further include a damper coupled to the upper elastic member 150 and the housing 140. Also, for example, the lens driving device 100 may further include a damper disposed between the second frame connection portion 163 of the lower elastic member 160 and the bobbin 110 (or housing 140). Also, for example, the lens driving device 100 may further include a damper disposed at the other end of the support member 220 and the terminal member 27. Also, for example, in another embodiment, the lens driving device 100 may further include a damper disposed between the inner side surface of the housing 140 and the outer peripheral surface of the bobbin 110.

The support member 220 may support the housing 140 to be movable in a direction perpendicular to the optical axis OA with respect to the base 210. The support member 220 may conductively connect at least one of the upper or lower elastic members 150 and 160 to the second circuit board 250.

For example, the support member 220 may be coupled to the upper elastic member 150 by solder or conductive adhesive and may be conductively connected to the upper elastic member 150. The support member 220 may be conductively connected to the second circuit board 250. For example, the support member 220 may conductively connect the upper elastic member 150 and the second circuit board 250.

The support member 220 may be implemented as a member capable of supporting elastically, for example, a wire, suspension wire, leaf spring, or coil spring. The support member 220 may include a conductive material. For example, the support member 220 may include a conductive metal.

For example, the support member 220 may be disposed at each corner portion of the housing 140. In another embodiment, the support member 220 may be disposed at the side portion of the housing 140.

The support member 220 may include a plurality of support members 220-1 to 220-6.

For example, at least one support member may be disposed at each corner portion 142-1 to 142-4 of the housing 140. For example, two support members may be disposed at each corner portion 142-1 to 142-4 of the housing 1400. For example, the lens driving device 100 may include a total of eight wires.

In another embodiment, one support member may be disposed at each corner portion of the housing 140. In another embodiment, two support members may be disposed on at least one of the corner portions of the housing 140, and one support member may be disposed at at least another one of the corner portions of the housing 140.

In another embodiment, for example, two support members may be disposed at each of two corner portions of the housing 140, and one support member may be disposed at each of the two corner portions of the housing 140. For example, two support members may be disposed at each of two corner portions of the housing facing each other in a first diagonal direction, and one support member may be disposed at each of two corner portions of the housing facing each other in a second diagonal direction. The first diagonal direction and the second diagonal direction may be directions that intersect each other. For example, the first diagonal direction and the second diagonal direction may be perpendicular to each other.

For example, each of the first to fourth support members 220-1 to 220-4 may be coupled to and conductively connected to a corresponding one of the first to fourth upper elastic members 150-1 to 150-4 by solder or conductive adhesive 902.

For example, each of the fifth and sixth support members 220-5 and 220-6 may be coupled to and conductively connected to a corresponding one of the fifth and sixth upper elastic members 150-5 and 150-6 by solder or conductive adhesive 902.

For example, the fifth upper elastic member 220-5 may include two wires 220-5A and 220-5B, and at least one of the two wires 220-5A and 220-5B may be conductively connected to the second circuit board 250. The sixth upper elastic member 220-6 may include two wires 220-6A and 220-6B, and at least one of the two wires 220-6A and 220-6B may be conductively connected to the circuit board 250.

For example, each of the first to fourth support members 220-1 to 220-4 may be conductively connected to a corresponding one of the first to fourth terminals 3A to 3D of the first circuit board through the first to fourth upper elastic members 150-1 to 150-4.

For example, each of the fifth and sixth support members 220-5 and 220-6 may conductively connected to a corresponding one of the fifth and sixth terminals 3E and 3F of the first circuit board 190 through the fifth to seventh upper elastic members 150-5 to 150-7.

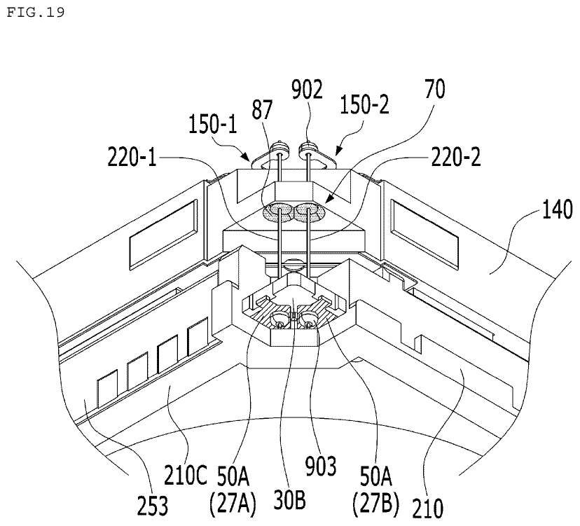

For example, the other end of the support member 220 may be coupled to and conductively connected to the terminal member 27 by solder or conductive adhesive 903 (see FIG. 19). For example, the other end of the support member 220 may be located inside the solder 903 and may not be exposed outside the solder (see FIG. 21). In another embodiment, for example, the other end of the support member 220 may protrude out of the solder 903 and be exposed to outside of the solder 903.

For example, the terminal member 27 may be conductively connected to the second circuit board 250, and the support member 220 may be conductively connected to the second circuit board 250 through the terminal member 27.

Each of the support members 220-1 to 220-6 may be conductively connected to a corresponding one of the terminal members 27A to 27F. For example, the support members 220-1 to 220-6 may conductively connect the upper elastic members 150-1 to 150-6 and the terminal portions 27A to 27F.

The support members 220-1 to 220-6 may be spaced apart from the housing 140, and are not fixed to the housing 140, but one ends of the support members 220-1 to 220 may be directly coupled or connected to the second coupling portion 92 of the upper elastic members 150-1 to 150-6 by solder or conductive adhesive 902, respectively.

For example, the first position sensor 170 may be conductively connected to the second circuit board 250 through the upper elastic member 150, the support member 220, and the terminal member 27.

In another embodiment, the terminal member 27 may be omitted, and the other end of the support member 220 may be directly connected or coupled to the second circuit board 250 using solder or conductive adhesive. For example, the other end of the support member 220 may be directly connected or coupled to the lower surface of the second circuit board 250. In another embodiment, the other end of the support member 220 may be coupled to the base 210, and a wiring or a circuit pattern may be formed at the base 210 for conductively connecting the other end of the support member 220 and the second circuit board 250.

In another embodiment, the support member 220 may be formed integrally with the upper elastic member 150.

Referring to FIGS. 8 to 9C, the second circuit board 250 is disposed below the housing 140 and/or the bobbin 110. Or, for example, the second circuit board 250 may be disposed below the lower elastic member 160. Or, for example, the second circuit board 250 may be disposed below the housing 140. For example, the second circuit board 250 may be disposed on the base 210.

For example, the second circuit board 250 may include a body 252 disposed on an upper surface of the base 210, and an opening 24A or a hollow formed at the body 252.

The opening 24A of the second circuit board 250 corresponds to at least one of the opening 25A of the bobbin 110, the opening 140A of the housing 140, and/or the opening 28A of the base 210.

For example, when viewed from the top side, the shape of the body 252 of the second circuit board 250 may match or correspond to the upper surface of the base 210, for example, may be a square shape.

The second circuit board 250 may include a terminal portion 253 extending from the body 252. The terminal portion 253 may be bent and extended from the body 252 to the side surface (or outer side surface) of the base 210. The body 252 may be expressed as “an upper part” or a first portion, and the terminal portion 253 may be expressed as “an extension part” or a second portion.

The terminal portion 253 of the second circuit board 250 may include a plurality of terminals 251 for receiving electrical signals from the outside or outputting electrical signals to the outside.

For example, the second circuit board 250 may include two terminal portions disposed on two sides of the body 252 that face each other. However, in another embodiment, the second circuit board 250 may include one or more terminal portions disposed at at least one or more side of the body 252.

A driving signal may be applied to each of the first position sensor 170, the second position sensor 240, and the second coil 230 through a plurality of terminals 251 provided on the terminal portion 253 of the second circuit board 250. The terminal portion 253 of the second circuit board 250 may receive the output signals of each of the first position sensor 170 and the second position sensor 240. Alternatively, in another embodiment, a driving signal may be supplied to the first coil 120 through the terminals 251.

For example, each of the first position sensor 170 and the second position sensor 240 may be conductively connected to a corresponding one of the terminals 251 of the second circuit board 250.

The second circuit board 250 may be implemented as a PCB or FPCB. In another embodiment, terminals may be formed directly on the surface of the base 210 using a surface electrode method, etc., instead of the second circuit board 250.

The second circuit board 250 may include an escape portion 23A through which the support member 220 passes to avoid spatial interference with the support member 220. In FIG. 8, the escape portion 23A may be formed at a corner of the body 252 and may have a cut shape or a groove shape. In another embodiment, the escape portion of the second circuit board 250 may be in the form of a hole or through hole, and the support member may pass through the hole or through hole of the second circuit board. In another embodiment, the second circuit board 250 may not have an escape portion, and the support members 220-1 to 220-4 may be conductively connected to a circuit pattern or pad formed on the upper surface of the second circuit board 250 through a solder, etc.

The second circuit board 250 may be coupled to and conductively connected to the second coil 230 using a solder or a conductive adhesive and may include at least one pad E1 to E6 or at least one terminal.

For example, the second circuit board 250 includes two pads E1 and E2 that are conductively connected to the first coil unit 230-1 of the second coil 230, and two pads E3 and E4 that are conductively connected to the second coil unit 230-2, and two pads E5 and E6 conductively connected to the third coil unit 230-3. For example, six pads E1 to E6 conductively connected to the second coil 230 may be disposed on the lower surface of the second circuit board 250. In an embodiment in which the second coil 230 is disposed on the upper surface of the second circuit board 250, pads conductively connected to the second coil 230 may be disposed on the upper surface of the second circuit board 250.

The second circuit board 250 may include pads Q1 to Q6 or terminals that are conductively connected to the terminal member 27 by solder or conductive adhesive.

For example, the second circuit board 250 may include a plurality of pads Q1 to Q6, and each of the plurality of pads Q1 to Q6 may be coupled to and conductively connected to a corresponding one of the plurality of terminal portions 27A to 27F.

Pads Q1 to Q6 may be disposed on at least one of the lower surface of the second circuit board 250 or the upper surface of the second circuit board 250. For example, the pads Q1 to Q6 may include at least one of a first portion disposed on the lower surface of the second circuit board 250 and a second portion disposed on the upper surface of the second circuit board 250. Additionally, the pads Q1 to Q6 may further include a third portion connecting the first portion and the second portion. For example, the third portion of the pads Q1 to Q6 may be disposed on the outer side surface of the second circuit board 250.

For example, the pads Q1 to Q6 may be disposed to contact an edge of the second circuit board 250 or a side surface of the second circuit board 250. For example, pads Q1 to Q6 may be disposed at corner portion of the second circuit board 250. For example, the pads Q1 to Q6 may be formed at the edge of the second circuit board 250 adjacent to the escape portion 23A of the second circuit board 250. Additionally, each of the pads Q1 to Q6 may be placed in contact with a corresponding one of the terminal members 27A to 27F. At least a portion of each of the pads Q1 to Q6 may overlap with the corresponding one of the terminal members 27A to 27F in the optical axis direction or the first direction.

Referring to FIG. 8 and FIGS. 14 to 17, the base 210 may be disposed below the second circuit board 250.

Additionally, the base 210 may be disposed below the housing 140 and/or the bobbin 110.

The base 210 may have an opening 28A corresponding to the opening 25A of the bobbin 110 or/and the opening 140A of the housing 140. The base 210 may have a shape that matches or corresponds to the cover member 300, and for example, the base 210 may have a square shape.

A support portion 255 or holding portion may be provided in a region of the base 210 facing the terminal 251 of the second circuit board 250. The support portion 255 of the base 210 may support the terminal portion 253 of the second circuit board 250 on which the terminal 251 is formed. For example, the support portion 255 may be in the form of a groove recessed from the outer surface of the base 210.

The base 210 may have an escape portion 212 formed at a corner or corner region thereof to avoid spatial interference with the support member 220. For example, the escape portion 212 may be in the form of a hole or through hole. In FIG. 14, the escape portion 212 may be a through hole formed in the stepped portion 30 of the base 210, but in another embodiment, the escape portion may be formed by cutting or removing a corner or corner region of the base 210 where the stepped portion 30 is omitted. In another embodiment, the escape portion may be in the form of a recess or a groove.

The base 210 may include a first surface 210A that contacts or supports the body 252 of the second circuit board 250. For example, the lower surface of the second circuit board 250 (or body 252) may be in contact with the first surface 210A of the base 210.

The base 210 may include a second surface 210B having a step difference from the first surface 210A in the optical axis direction. For example, the second surface 210B may be located below the first surface 210A. For example, the second surface 210B may be closer to the lower surface of the base 210 than the first surface 210A. For example, the second surface 210B may be position between the opening 28A of the base 210 and the outer side surface of the base 210.

The second coil 230 may be disposed on the base 210. For example, the second coil 230 may be disposed on the upper surface of the base 210. For example, the second coil 230 may be disposed between the base 210 and the second circuit board 250. For example, the second coil 230 may be disposed on the second surface 210B of the base 210. For example, the second coil 230 may be in contact with the second surface 210B of the base 210.

The base 210 may include a first region where the second coil 230 is placed and a second region where the second coil 230 is not disposed.

For example, the first region of the base 210 may be alternatively expressed as a “receiving part” or “receiving region.” For example, the first region of the base 210 may be expressed as a “seating portion.” The first region of the base 210 may be a groove 213A to 213C or a recess. For example, the grooves 213A to 213C of the base 210 are recessed from the first surface 210A of the base 210. For example, the bottom surface of the grooves 213A to 213C of the base 210 may be the second surface 210B of the base 210. The outer surface of the base 210 may include an open region.

For example, the first region of the base 210 may include a bottom surface (e.g., 210B) positioned lower than the uppermost surface of the base 210. Additionally, the first region of the base 210 may include a protrusion 215, a protruding region, or a protruding portion disposed on the bottom surface 210B.

At least a portion of the second coil 230 may be disposed in the first region of the base 210. The second circuit board 250 may be disposed on the first region of the base 210, and the lower surface of the second circuit board 250 may be spaced apart from the bottom surface 210B of the first region of the base 210. The first region of the base 210 may include a protrusion 215, a protruding region, or a protrusion that protrudes higher than the bottom surface 210B. For example, the protrusion 215 may protrude from the second surface 210B of the base 210.

For example, the protrusion 215, protruding region, or protruding portion of the first region of the base 210 may be disposed in the hollow (or central hole) of the coil units 230-1 to 230-3 of the second coil 230. For example, the base 210 may include three grooves 213A to 213C to accommodate three coil units 230-1 to 230-3. For example, a depth of each of the grooves 213A, 213B, and 213C may be greater than a length of the coil units 230-1 to 230-3 of the second coil 230 in the optical axis direction. This prevents the second circuit board 250 to which the coil unit is coupled from being lifted or separated from the first surface 210A of the base 210, and this also prevents the coupling force between the second circuit board 250 and the base 210 from weakening.

In another embodiment, the depth of the grooves 213A, 213B, and 213C may be equal to the length of the coil units 230-1 to 230-3 of the second coil 230 in the optical axis direction. In another embodiment, the depth of the grooves 213A to 213C may be smaller than the length of the coil units 230-1 to 230-3 of the second coil 230 in the optical axis direction. For example, the depth of the grooves 213A to 213C may be a distance from the first surface 210A of the base 210 to the bottom surface 210B of the grooves 213A to 213C.

The base 210 may include a third surface 30A positioned below the first surface 210A. The third surface 30A may be disposed at a corner of the base 210. For example, the third surface 30A may be an upper surface of the stepped portion 30 of the base 210. For example, the third surface 30A may be disposed adjacent to the escape portion 212 of the base 210. For example, the third surface 30A may be positioned higher than the lower surface of the base 210. For example, the third surface 30A may be located lower than the second surface 210B. In another embodiment, the third surface 30A may be higher than the second surface 210B or may have the same height.

For example, the first surface 210A, the second surface 210B, and the third surface 30A may be parallel to each other. Also, for example, the first surface 210A, the second surface 210B, and the third surface 30A may be perpendicular to the optical axis. In another embodiment, at least one of the first to third surfaces may not be parallel to the others.

The base 210 may further include a groove 213D formed on the first surface 210A and recessed from the first surface 210A. The groove 213D may be formed in other region of the first surface 210A of the base 210 excluding regions where the other grooves 213A to 213C are formed.

For example, the base 210 may be an injection molding material. By forming the groove 213D in the other region of the base 210, it can be prevented that a thickness of the other region of the base 210 is formed to be abnormally thick.

The base 210 may include a step 211 on which an adhesive can be applied when the cover member 300 is fixed to the base by adhesive. At this time, the step 211 may be formed on the outer surface of the base 210. The step 211 is configured to guide the side plate 302 of the cover member 300. The step 211 faces the lower end of the side plate 302 of the cover member 300. For example, the step 211 and the side plate 302 of the cover member 300 may be coupled to each other using an adhesive. Additionally, a seating portion (not shown) where the filter 610 of the camera device 200 is installed may be formed at the lower surface of the base 210.

A guide protrusion 217 may be formed at an edge of the upper surface of the base 210 and protrude from the upper surface (e.g., first surface 210A) of the base 210. The guide protrusion 217 serves to guide the body 252 of the second circuit board 250 and support the side surface of the body 252 to prevent the body 252 from falling out of the base 210.

For example, the second coil 230 may be disposed between the lower surface of the second circuit board 250 and the upper surface (e.g., first surface 210A) of the base 210.

The second coil 230 may include a plurality of coil units. For example, the second coil 230 may include first to third coil units 230-1 to 230-3.

For example, the first coil unit 230-1 may face or overlap the first magnet unit 130-1 in the optical axis direction, and the second coil unit 230-2 may face or overlap the second magnet unit 130-2 in the optical axis direction, 130-2 and the third coil unit 230-3 may face or overlap the third magnet unit 130-3 in the optical axis direction.

For example, three magnets 130-1 to 130-3 may be disposed on three of the four side portions of the housing 140, and the first to third coil units 230-1 to 230-3 may be disposed on three side portions or three sides of the base 210 to correspond to or face the magnets 130-1 to 130-3 in the optical axis direction.

In another embodiment, the three magnets may be disposed on three of the four corner portions of the housing 140, and the first to third coil units may disposed on three corners of the base 210 so as to correspond to or face the magnets 130-1 to 130-3 in the optical axis direction.

Each of the first to third coil units 230-1 to 230-3 may have a hollow or a closed curve with a central hole, for example, a ring shape, and the central hole may be formed to face the optical axis direction.

For example, each of the first to third coil units 230-1 to 230-3 may be in the form of a winding coil, coil bundle, coil body, or coil block rather than a fine pattern (FP) coil. FP coil cannot secure a sufficient number of coil turns due to problems such as resistance during manufacturing, and the number of coil turns is limited. As a result, electromagnetic force due to interaction with the magnet 130 may be reduced or weakened. In a structure in which two support members are disposed at each corner of the housing 140 according to the embodiment, sufficient electromagnetic force is required to overcome the restoring force of the support members, but in case that FP coil is used, such sufficient electromagnetic force cannot be secured.

On the other hand, the winding coil has no limitation to the number of coil turns and can have a number of turns 1.5 times or more than the number of turns of the FP coil. For example, under conditions of the same resistance, the winding coil can secure 1.5 times more turns than the FP coil.

Because of this, the embodiment can secure a sufficient number of turns of the second coil 230 and secure sufficient electromagnetic force to overcome the restoring force of the support member 220 when OIS driving is performed.

In another embodiment, the second coil 230 may be implemented as a fine pattern (FP) coil.

The protrusion 215 of the base 210 may be coupled to, inserted into, or disposed in the hollow (or central hole) of the coil units 230-1 to 230-3 of the second coil 230.

For example, a height of the protrusion 215 may be lower than or equal to the height of the upper surface or an upper end of the second coil 230 (or coil units 230-1 to 230-3). The height of the protrusion 215 may be less than or equal to the length of the coil units 230-1 to 230-3 in the optical axis direction. The height of the protrusion 215 may be a protruding height of the protrusion 215.

For example, the upper surface of the protrusion 215 may be lower than or equal to the first surface 210A of the base 210. This is because if the height of the protrusion 215 is higher than the first surface 210A of the upper surface of the base 210, the lower surface of the second circuit board 250 and the first surface 210A of the base 210 may be lifted or separated.

For example, the first to third coil units 230-1 to 230-3 may be fixed or attached to the lower surface of the second circuit board 250 and may be conductively connected to the second circuit board using solder or conductive adhesive.

The second position sensor 240 may be conductively connected to the second circuit board 250. The second position sensor 240 may be disposed or mounted on the second circuit board 250. The second position sensor 240 may be disposed on the base 210. The base 210 may include seating portions 214 (214A, 214B) on which the second position sensor 240 is disposed or seated. For example, the seating portions 214A and 214B may be in the form of a groove or a hole. For example, the seating portions 214A and 214B may be disposed within the grooves 213A and 213C of the base 210. For example, the seating portions 214A and 214B may be formed at the protrusion 215 of the base 210.

For example, the second position sensor 240 may be disposed between the second circuit board and the base 210. For example, the second position sensor 240 may be fixed or attached to the lower surface of the second circuit board 250 using solder or conductive adhesive and may be conductively connected to the second circuit board 250.

The second position sensor 240 may include a first sensor 240A and a second sensor 240B that are spaced apart from each other. For example, the first sensor 240A and the second sensor 240B may be disposed between the second circuit board 250 and the base 210. For example, the first sensor 240A and the second sensor 240B may be disposed between the lower surface of the second circuit board 250 and the upper surface of the base 210.

The second position sensor 240 may detect the displacement or position of the housing 140 in a direction perpendicular to the optical axis. For example, when the housing 140 moves in a direction perpendicular to the optical axis, the second position sensor 240 can detect the magnetic field of the magnet 130 and output an output signal. The displacement (or position) of the housing 140 in a direction perpendicular to the optical axis can be detected using the output signal of the second position sensor 240.

Each of the first sensor 240A and the second sensor 240B may be a Hall sensor, and any sensor that can detect the magnetic field strength can be available. For example, each of the first and second sensors 240A and 240B may be implemented as a position detection sensor such as a Hall sensor or may be implemented as a driver IC including a Hall sensor.

For example, the first sensor 240A may be disposed in the central hole of the first coil unit 230-1, and the second sensor 240B may be disposed in the central hole of the third coil unit 230-3. In another embodiment, the first sensor 240A may be located outside the central hole of the first coil unit 230-1, and the second sensor 240B may be located outside the central hole of the third coil unit 230-3.

For example, the first sensor 240A may correspond to, face, or overlap the first magnet unit 130-1 in the optical axis direction, and the second sensor 240B may correspond to, face, or overlap the third magnet unit 130-3 in the optical axis direction.

For example, the first sensor 240A may detect the first magnet unit 130-1 (or the strength of the magnetic field of the first magnet unit) and output a first output signal. The second sensor 240B may detect the third magnet unit 130-3 (or the strength of the magnetic field of the third magnet unit) and output a second output signal. The displacement (or position) of the OIS movable unit in a direction perpendicular to the optical axis may be detected using the first and second output signals. Here, the OIS movable unit may include an AF movable unit and components mounted on the housing 140.

For example, the first sensor 240A and the second sensor 240B may not overlap the second coil 230, for example, the first to third coil units 230-1 to 230-3, in the optical axis direction.

For example, the first sensor 240A and the second sensor 240B may be conductively connected to the terminals 251 of the second circuit board 250. For example, a driving signal may be supplied to each of the first sensor 240A and the second sensor 240A through the terminals 251 of the second circuit board 250, and the first output signal of the first sensor 240A and the second output signal of the second sensor 240B may be output through the terminals 251 of the second circuit board 250.

The controller 830 of the camera device 200 or the controller 780 of the portable terminal 200A may sense or detect the displacement of OIS movable unit using the first output signal of the first sensor 240A and the second output signal of the second sensor 240B.

OIS movable unit (e.g., housing 140) may move in a direction perpendicular to the optical axis, for example, in the x-axis and/or y-axis direction by an interaction between the first to third magnet units 130-1 to 130-3 and the first to third coil units 230-1 to 230-3. Due to this, hand-shake correction may be performed.

The Base 210 may include side portions and corner portions (or corners). For example, the base 210 may include four side portions and four corner portions. The three grooves 213A to 213C described above may be formed at three of the four side portions of the base 210, and the groove 213D described above may be formed at the remaining side portion. The corner portions of the base 210 may correspond to or face the corner portions 142-1 to 142-4 of the housing 140 in the optical axis direction.

The above-described escape portion 212 may be formed at the corner portions of the base 210, and the third surface 30A may be formed at the corner portions of the base 210. For example, the base 210 may include a stepped portion 30 including a first surface 210A and a third surface 30A having a step difference in the optical axis direction. For example, the stepped portion 30 may be a region of the corner portion of the base 210. For example, the escape portion 212 may be formed at the stepped portion 30 of the base 210. For example, the escape portion 212 may penetrate the stepped portion 30 in the optical axis direction. For example, the escape portion 212 may overlap the support member 220 in the optical axis direction.

The terminal member 27 may be disposed on the base 210 or may be coupled to the base 210.

At least a portion of the terminal member 27 may be inserted into the base 210 using the insert injection method. For example, the terminal member 27 may be insert-molded with the base 210, and at least a portion of the terminal member 27 may be inserted into the base 210 or disposed inside the base 210. In another embodiment, the terminal member 27 may be coupled or attached to the base 210 with an adhesive.

For example, the terminal member 27 may be disposed below the circuit board 250 (e.g., body 252). For example, the terminal member 27 may be disposed at a corner portion (or corner) of the base 210. In another embodiment, the terminal member may be disposed on the side portion of the base 210. For example, the terminal member 27 may be disposed at the stepped portion 30 of the base 210 or may be coupled to the stepped portion 30.

The terminal member 27 may be coupled or connected to the other end of the support member 220 using solder or conductive adhesive 903 (see FIG. 19). The terminal member 27 may be conductively connected to the support member 220 and the second circuit board 250. The terminal member 27 may conductively connect the support member 220 and the second circuit board 250.

Referring to FIGS. 8 and 15, the terminal member 27 may include at least one terminal. For example, the terminal member 27 may include a plurality of terminals 27A to 27F spaced apart from each other. For example, the terminal member 27 may include as many terminals as the number of support members. The terminal member 27 may include a conductive material, for example, a conductive metal.

The terminal member 27 includes a first portion 50A coupled to the support member 220 by solder or a conductive adhesive, a second portion 51A coupled to the second circuit board 250 by solder or a conductive adhesive, and a third portion 51B connecting the first portion 50A and the second portion 51A. The first portion 50A may be expressed as a “first coupling portion,” the second portion 51A may be expressed as a “second coupling portion,” and the third portion 51B may be expressed as a “second coupling portion,” and the third portion 51B may be expressed as “connection portion.” Additionally, the first portion 50A may be alternatively expressed as a “body”, and the second portion 51A and the third portion 51B may be alternatively expressed as an “extension portion 50B.”

One end of the extension portion 50B may be conductively connected to the second circuit board 250. For example, one end of the extension portion 50B may be coupled to and conductively connected to the pads Q1 to Q6 of the second circuit board 250 using solder or conductive adhesive. For example, the extension portion 50B of each of the plurality of terminals 27A to 27F may be coupled to and conductively connected to a corresponding one of the pads Q1 to Q6 of the second circuit board 250 using solder or conductive adhesive.

The first portion 50A of the terminal member 27 may include a coupling region for being coupled to the support member 220. The coupling region may be a region of the first portion 50A where the support member 220 and the solder 903 are connected. The coupling region of the terminal member 27 may include a hole 81 through which the other end of the support member 220 passes. The hole 81 may be a through hole penetrating the first portion 50A. The terminal member 27 may include as many holes 81 as the number of support members 220 coupled to the first portion 50A.

The support member 220 may pass through the hole 81 and the other end of the support member 220 may be coupled to the lower portion or lower surface of the first portion 50A by solder 903 or a conductive adhesive. For example, a diameter of the hole 81 may be larger than a diameter of the support member 220.

The terminal member 27 may include at least one hole 82 for being coupled to the base 210. For example, at least one hole 82 may be a through hole penetrating the first portion 50A of the terminal member 27. For example, the base 210 may include a coupling protrusion 77 (see FIG. 10C) to be coupled to at least one hole 82.

The terminal member 27 may be disposed between the circuit board 250 and the lower surface 210C of the base 210 (see FIG. 19 (or the lowermost end)).

The first portion 50A of the terminal member 27 may be disposed between the first surface 210A of the base 210 and the lower surface 210C (see FIG. 19 (or the bottom)) of the base 210. For example, the first portion 50A of the terminal member 27 may be disposed at the stepped portion 30 of the base 210. For example, the first portion 50A of the terminal member 27 may be disposed on or coupled to the lower surface 30B of the stepped portion 30 of the base 210. For example, the lower surface 30B of the stepped portion 30 may be positioned higher than the lower surface 210C of the base 210 and positioned lower than the first surface 210A of the base 210.

In another embodiment, the first portion 50A of the terminal member 27 may be disposed at or coupled to the upper surface (or third surface 30A) of the stepped portion 30 of the base 210. For example, the upper surface of the terminal member 27 may be positioned higher than the lower surface of the base 210 and lower than the first surface 210A of the base 210.

For example, the lower surface of the first portion 50A of the terminal member 27 may be positioned lower than the lower surface of the coil unit (e.g., 230-2) of the second coil 230. For example, the upper surface of the first portion 50A of the terminal member 27 may be positioned lower than the lower surface of the coil units 230-1 to 230-3 of the second coil 230. In another embodiment, for example, the lower surface (or upper surface) of the first portion 50A of the terminal member 27 may be positioned on the same plane as the lower surface of the coil units 230-1 to 230-3 of the second coil 230. In another embodiment, for example, the lower surface (or upper surface) of the first portion 50A of the terminal member 27 may be positioned higher than the lower surface of the coil units 230-1 to 230-3 of the second coil 230.

The first portion 50A of the terminal member 27 may be disposed on or coupled to the stepped portion 30 of the base 210. For example, the first portion 50A of the terminal member 27 may be disposed on or coupled to the lower surface 30B of the stepped portion 30 of the base 210. At least a portion of the first portion 50A of the terminal member 27 may be exposed from the lower surface 30B of the stepped portion 30 of the base 210. The other end of the support member 220 may be coupled to at least a portion of the first portion 50A of the terminal member 27 exposed from the lower surface 30B of the stepped portion 30 using solder 903 or a conductive adhesive.

In another embodiment, the first portion 50A of the terminal member 27 may be disposed on or coupled to the upper surface 30A of the stepped portion 30.

The first portion 50A of the terminal member 27 may be positioned lower than the second circuit board 250. For example, the first portion 50A of the terminal member 27 may be positioned lower than the lower surface of the second circuit board 250.

A portion of the extension portion 50B may be connected to the first portion 50A. Another portion of the extension part 50B may be exposed from the first surface 210A of the base 210, and the another portion of the exposed extension portion 50B may be attached to the pads (Q1 to Q6) of the second circuit board 250 by solder or a conductive adhesive. For example, the base 210 may expose the second portion 51A of the terminal member 27. For example, referring to FIG. 8, an opening 29 may be formed in the first surface 210A of the base 210 to expose the second portion 51A of the terminal member 27. For example, openings 29A to 29F may be formed at the first surface 210A of the base 210 to expose the second portions 51A of the terminals 27A to 27F of the terminal member 27.

Referring to FIG. 9C, the another portion of the exposed extension portion 50B of each of the terminals 27A to 27F may be disposed adjacent to a corresponding one of the pads Q1 to Q6. For example, the extension portion 50B may include at least one bent or curved portion.

For example, a width (or area) of the second portion 51A may be smaller than a width (or area) of the first portion 50A. A width (or area) of the third portion 51B may be smaller than the width (or area) of the first portion 50A. For example, the third portion 51B may include a portion having a width smaller than the width of the second portion 51A.

In FIG. 15, the plurality of terminals 27A to 27F are spaced apart from each other, but in another embodiment, two or more terminals among the plurality of terminals may be connected to each other or formed as one body.

In the embodiment, since the first portion 50A of the terminal member 27 coupled to the support member 220 is positioned lower than the lower surface of the second circuit board 250, a length of the support member 220 in the optical axis direction can be increased. As the length of the support member 220 increases, the resistance of the support member 220 may increase and the intensity of the current flowing through the support member 220 may decrease. As a result, in the embodiment, deterioration in reliability of OIS operation due to reduction of OIS wire diameter to reduce power consumption can be prevented.

In the embodiment of FIG. 2, the second coil 230 includes three coil units, but in the embodiment in which the magnet 130 includes four magnet units, the second coil 230 may include four coil units. Two of the four coil units may be positioned opposite to each other in an X-axis direction perpendicular to the optical axis (e.g., Z-axis) and the rest two of four coil units may be positioned opposite to each other in a Y-axis direction.

In the embodiment of FIG. 2, the second coil 230 is disposed below the second circuit board 250, but in another embodiment, the second coil may be disposed on the second circuit board 250. For example, in another embodiment, the second coil may be disposed below the housing 140 and/or the bobbin 110. For example, in another embodiment, the second coil may be in the form of a coil block formed of FP (Fine pattern) coil. Alternatively, the second coil may include a circuit member having a hollow (or hole) corresponding to the hollow 24A of the circuit board 250 and a plurality of coil units formed on the circuit member. Here, the circuit member may be expressed as a “substrate”, “circuit board”, or “coil board”.

The cover member 300 may accommodate the OIS movable unit, the upper elastic member 150, the lower elastic member 160, the second coil 230, the base 210, and the terminal member 27, the second circuit board 250, the support member 220, and the second position sensor 240 in a receiving space formed together with the base 210.

The cover member 300 may have the form of a box which is open at a lower portion thereof and include the upper plate 301 and side plates 302, and the lower portion of the side plate 302 of the cover member 300 is a step 211 of the base 210 can be combined. The shape of the upper plate 301 of the cover member 300 may be polygonal, for example, square or octagonal.

The cover member may include an opening 303 formed at the upper plate 301 to expose the lens module 400 coupled to the bobbin 110 to external light. The material of the cover member 300 may be a non-magnetic material such as SUS to avoid sticking to the magnet 130. The cover member 300 may be formed of a metal plate, but is not limited thereto, and may also be formed of plastic. Additionally, the cover member 300 may be connected to a ground terminal of the second circuit board 250 of the lens driving device or/and a ground of the circuit board 800 of the camera device 200. The cover member 300 can block electromagnetic interference (EMI).

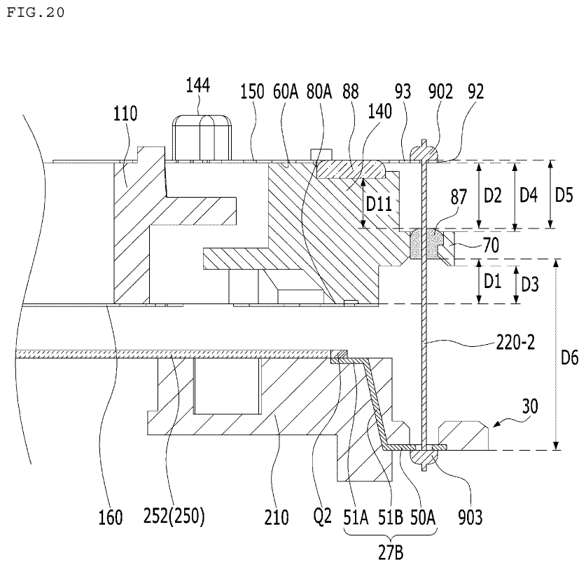

FIG. 18 is a perspective view of a portion of the lens driving device 100 of FIG. 2, FIG. 19 is a perspective view of a portion of the lens driving device 100 of FIG. 18 in another direction, and FIG. 20 is a cross-sectional view of the lens driving device 100 of FIG. 18.

FIGS. 18 to 20, the damper 88 may be disposed between the housing 140 and the upper elastic member 150 (e.g., the first outer frame 152 or the connection portion 93). The damper 88 may be in contact with, coupled to, or attached to the housing 140 and the upper elastic member 150 (e.g., the first outer frame 152 or the connection portion 93).

The damper 88 may alleviate vibration of the upper elastic member 150. For example, the damper 88 may alleviate vibration of the first outer frame 152 or the connection portion 93. For example, the damper 88 may alleviate vibration of the housing 140 coupled to the first outer frame 152 when OIS operation is performed. For example, the damper 88 may be spaced apart from the first inner frame 151. For example, the damper 88 may be spaced apart from the first frame connection portion 153. Also for example, the damper 88 may be spaced apart from support member 220. Also, for example, the damper 88 may be spaced apart from the second coupling portion 92.

For example, the damper 88 may be disposed at the corner portion 142 of the housing 140. In another embodiment, the damper 88 may be disposed on the side portion 141 of the housing 140.

For example, the damper 87 may be disposed between the side portion (or outer side surface) of the housing 140 and the support member 220, and may be in contact with, coupled to, or attached to the side portion (or outer side surface) of the housing 140 and the support member 220.

For example, the damper 87 may be disposed below the damper 88. For example, the uppermost portion of the damper 87 may be disposed below the lowermost portion of the damper 88. For example, the damper 87 may be spaced apart from the damper 88.

For example, the damper 87 may be spaced apart from the upper elastic member 150. For example, the damper 87 may be spaced apart from the lower elastic member 160. For example, the damper 87 may be spaced apart from the first outer frame 152. For example, the damper 87 may be spaced apart from the second coupling portion 92. Also, for example, the damper 87 may be spaced apart from one end of the support member 220 coupled to the second coupling portion 92. Also, for example, the damper 87 may be spaced apart from the terminal member 27. For example, the damper 87 may be spaced apart from the other end of the support member 220 coupled to the terminal member 27. The damper 87 may be disposed between one end of the support member 220 and the other end of the support member 220.

The damper 87 may be disposed on the protruding portion 70 of housing 140. For example, the damper 87 may be in contact with, coupled with, or attached to the protruding portion 70 of the housing 140. For example, the damper 87 may be disposed within the recess 65 of the protruding portion 70 of the housing 140. For example, at least a portion of the damper 87 may be disposed within at least one hole 147 of the protruding portion 70.

For example, the damper 87 may be disposed at the corner portion 142 of the housing 140. In another embodiment, the damper 87 may be disposed on the side portion 141 of the housing 140.

Hereinafter, a position of the damper 87 or a relative position of any configuration being compared with the damper 87 will be described.

For example, the damper 87 may be disposed closer to the lower surface 80A of the housing 140 (or the lowermost portion of the housing 140) than to the upper surface (or the first surface 60A) of the housing 140. In another embodiment, for example, when indicating the relative position of the damper 87, the upper surface of the housing 140 may be the uppermost portion of the housing 140, and the lower surface of the housing 140 may be the lowermost portion of the housing 140.

For example, the first separation distance D1 between the damper 87 and the lower surface 80A of the housing 140 is smaller than the second separation distance D2 between the damper 87 and the upper surface (or first surface 60A) of the housing 140 (D1<D2). For example, the first separation distance D1 is a distance in the optical axis direction between an imaginary line (or an extension line) parallel to the lower surface 80A of the housing 140 (or the lowest portion of the housing 140) and the lowermost portion of the damper 87. The second separation distance D2 may be a distance in the optical axis direction between an imaginary line (or an extension line) parallel to the upper surface (or first surface 60A) of the housing 140 and the uppermost portion of the damper 87.

For example, the damper 87 may be disposed closer to the lower elastic member 160 than to the upper elastic member 150. For example, the third separation distance in the optical axis direction between the damper 87 and the lower elastic member 160 is smaller than the fourth separation distance in the optical axis direction between the damper 87 and the upper elastic member 150 (e.g., the second coupling portion 92). For example, the third separation distance may be a distance in the optical axis direction between an imaginary line (or an extension line) parallel to the upper surface of the lower elastic member 160 and the lowermost portion of the damper 87. For example, the fourth separation distance may be a distance in the optical axis direction between the uppermost portion of the damper 87 and the lower surface of the upper elastic member 150 (e.g., the second coupling portion 92).

For example, the damper 87 is positioned closer to the second coupling portion 148 of the housing 140 coupled to the second outer frame 162 than the first coupling portion 143 of the housing 140 coupled to the first outer frame 152.

For example, the fifth separation distance in the optical axis direction between the damper 87 and the second coupling portion 148 of the housing 140 is smaller than the sixth separation distance in the optical axis direction between the damper 87 and the first coupling portion 143. For example, the fifth separation distance may be a distance in the optical axis direction between the lowermost portion of the damper 87 and an imaginary line (or extension line) parallel to the lowermost portion of the first coupling portion 143. For example, the sixth separation distance may be a distance in the optical axis direction between the uppermost portion of the damper 87 and an imaginary line (or extension line) parallel to the uppermost portion of the first coupling portion 143.

For example, the damper 87 is disposed closer to the lower surface 80A of the housing 140 (or the lowermost portion of the housing 140) than one end of the support member 220 coupled to the second coupling portion 92 of the first outer frame 152. For example, the first separation distance D1 in the optical axis direction between the damper 87 and the lower surface 80A of the housing 140 (or the lowermost portion of the housing 140) may be smaller than the separation distance in the optical axis direction between the damper 87 and one end of the support member 220. Here, one end of the support member 220 may be a part of the support member 220 that is coupled to the second coupling portion 92.

Also, for example, the damper 87 may be disposed closer to the lower elastic member 160 than the one end of the support member 220 coupled to the second coupling portion 92 of the first outer frame 152.

For example, the third separation distance in the optical axis direction between the damper 87 and the lower elastic member 160 may be smaller than the separation distance in the optical axis direction between the damper 87 and the one end of the support member 220.

For example, the damper 87 may overlap the second coupling portion 92 in the optical axis direction. For example, the damper 87 may overlap the one end of the support member 220 coupled to the second coupling portion 92 in the optical axis direction. The second coupling portion 92 may overlap the terminal member 27 (or the first portion 50A) in the optical axis direction.

For example, the damper 87 may not overlap the damper 88 in the optical axis direction. For example, the damper 87 may not overlap the damper 88 in a direction perpendicular to the optical axis. The damper 87 may overlap at least a portion of the base 210 in the optical axis direction. In another embodiment, the damper 87 may not overlap the base 210 in the optical axis direction.

For example, the protruding portion 70 of the housing 140 may be positioned closer to the lower surface 80A of the housing 140 (or the lowermost portion of the housing 140) than the upper surface (or the first surface 60A) of the housing 140. For example, the first distance D3 in the optical axis direction between the lower surface 80A (or the lowermost portion of the housing 140) of the housing 140 and the protruding portion 70 may be smaller than the second distance D4 in the optical axis direction between the upper surface (or first surface 60A) of the housing 140 and the protruding portion 70. For example, the first distance D3 is a distance in the optical axis direction between the lowermost portion (or a lower surface) of the protruding portion 70 and an imaginary line (or extension line) parallel to the lower surface 80A of the housing 140 (or the lowermost portion of the housing 140). For example, the second distance D4 is a distance in the optical axis direction between an imaginary line (or extension line) parallel to the upper surface (or first surface 60A) of the housing 140 and the upper surface 60B of the protruding portion 70.

For example, the first distance D3 may be greater than or equal to 0 and less than or equal to 0.8 [mm]. Or, for example, the first distance D3 may be 0.45 [mm] to 0.65 [mm]. Or, for example, the first distance D3 may be 0.5 [mm] to 0.6 [mm]. When the first distance D3 is 0, a height of the lower surface (or the lowermost portion) of the protruding portion 70 may be the same as a height of the lower surface 80A of the housing 140 (or the lowermost portion of the housing 140). When the first distance D3 is 0, the damper 87 can be positioned close to a center position of the support member 220, the damping force of the damper 87 can be increased, and the stabilization time for vibration of the housing can be reduced.

When the first distance D3 is greater than 0.75 [mm], the damper 87 may be disposed close to the coupling portion (e.g., 902, which is a fixed part) between the upper elastic member 150 and the support member 220, and the damper 87, and the damping force may be reduced and the reduction in stabilization time for vibration of the housing may be minimal.

For example, the second distance D4 may be greater than or equal to 0.85 [mm] and may be less than a reference value. For example, the reference value may be a value obtained by subtracting the length of the protruding portion 70 in the optical axis direction from the height (or length) in the optical axis direction from the upper surface 60A (or first surface) of the housing 140 to the lower surface 80A (or lowermost portion) of the housing 140.

For example, the length of the protruding portion 70 in the optical axis direction may be 0.3 [mm] to 0.55 [mm]. Alternatively, the length of the protruding portion 70 in the optical axis direction may be 0.4 [mm] to 0.5 [mm]. Alternatively, the length of the protruding portion 70 in the optical axis direction may be 0.45 [mm] to 0.5 [mm].

For example, the second distance D4 may be 0.9 [mm] to 1.2 [mm]. Or, for example, the second distance D4 may be 0.95 [mm] to 1.15 [mm]. When the second distance D4 is less than 0.85 [mm], the damper 87 may be disposed close to the coupling portion (e.g., 902, which is a fixed part) between the upper elastic member 150 and the support member 220, and because of this, the damping force of the damper 87 may be reduced and the reduction in stabilization time for vibration of the housing may be minimal.

For example, the difference between the first distance D3 and the second distance D4 may be 0.05 [mm] to 1.45 [mm]. Or, for example, the difference between the first distance D3 and the second distance D4 may be 0.3 [mm] to 0.8 [mm]. Or, for example, the difference between the first distance D3 and the second distance D4 may be 0.45 [mm] to 0.55 [mm].

For example, the upper surface 60B of the protruding portion 70 of the housing 150 is closer to the upper surface (or first surface 60A) of the housing 140 than the lower surface 80A of the housing 140 (or the lowest part of the housing 140). For example, the separation distance in the optical axis direction between the upper surface 60B of the protruding portion 70 and the lower surface 80A of the housing 140 (or the lowermost portion of the housing 140) may be smaller than the separation distance in the optical axis direction between the upper surface 60B of the protruding portion 70 and the upper surface (or first surface 60A) of the housing 140. In other embodiments, the former may be greater than or equal to the latter.

For example, the separation distance D5 in the optical axis direction between the damper 87 and one end of the support member 220 may be smaller than the separation distance D6 in the optical axis direction between the damper 87 and the other end of the support member 220 (D5<D6). For example, one end of the support member 220 may be a portion of the support member 220 that is coupled to the upper elastic member 150 (e.g., the second coupling portion 92) by solder 902. For example, the other end of the support member 220 may be another portion of the support member 220 that is coupled to the terminal member 27 (e.g., the first portion 50A) by solder 903. In another embodiment, the separation distance in the optical axis direction between the damper 87 and one end of the support member 220 may be greater than or equal to the separation distance in the optical axis direction between the damper 87 and the other end of the support member 220.

For example, the damper 87 may be disposed closer to the lower surface of the magnet 130 than to the upper surface or first surface 60A of the housing 140. For example, the damper 87 may be disposed closer to the upper surface of the magnet 130 than to the lower surface of the magnet 130. In another embodiment, the damper 87 may be disposed closer to the lower surface of the magnet 130 than to the upper surface of the magnet 130. In another embodiment, the separation distance in the optical axis direction between the upper surface of the magnet 130 and the damper 87 may be equal to the separation distance between the lower surface of the magnet 130 and the damper 87.

For example, the damper 87 may be disposed closer to the lower surface 80A of the housing 140 than the damper 88. For example, the first separation distance D1 between the damper 87 and the lower surface 80A of the housing 140 may be smaller than the separation distance D11 between the damper 87 and the damper 88 (D1<D11). For example, D11 may be a distance in the optical axis direction between an imaginary line (or an extension line) parallel to the lower surface (or lowermost portion) of the damper 88 and the uppermost portion of the damper 87.

In another embodiment, the damper 87 may be disposed closer to the damper 88 than the lower surface 80A of the housing 140. In another embodiment, D11 and D1 may be equal to each other.

For example, a volume of the damper 87 may be smaller than a volume of the damper 88, and in other embodiment, the former may be larger than or equal to the latter.

Also, for example, a contact area between the damper 87 and the housing 140 may be smaller than a contact area between the damper 88 and the housing 140, and in other embodiment, the former may be larger than or equal to the latter.

The lens driving device according to a comparative example may include a single damper attached together to the support member 220 and the upper elastic member 150 (e.g., the second coupling portion 92) instead of the damper 87. In the damper according to the comparative example, a damper restraint force applied to the support member 220 from the single damper and a damper restraint force applied to the upper elastic member 150 from the single damper may be mixed. In this way, when the damper restraint force applied to the support member 220 and the damper restraint force applied to the upper elastic member 150 are mixed, it is difficult to precisely control the vibration of the housing 140 during OIS operation.

In the embodiment, the damper 88 and the damper 87 are disposed to be spaced apart from each other, the damper 88 can control the damper restraint force to the upper elastic member 150, and the damper 87 can control the damper restraint force to the support member 220. That is, in the embodiment, independent and individual control of the damper restraint force for each of the upper elastic member 150 and the support member 220 may be possible, and thus, precise control of the vibration of the housing 140 during OIS operation may be possible.

Additionally, in the embodiment, the vibration absorption effect of the housing 140 during OIS operation can be maximized by using the two independently divided dampers 88 and 87.

Additionally, in the embodiment, since the damper 87 is disposed between the protruding portion 70 of the housing 140 and the support member 220, the contact area between the damper 87 and the housing 140 can be increased, and therefore, the vibration reduction effect of the housing 140 can be increased.

Additionally, in the embodiment, since the damper 87 is disposed in the recess 65 formed in the protruding portion 70 of the housing 140, the damper 87 can be easily attached to or accommodated in the housing 140, and the damper 87 can be prevented from being separated from the housing 140 due to vibration of the housing 140.

Additionally, in the embodiment, since the damper 87 is disposed in at least one hole 147 formed in the protruding portion 70 of the housing 140, the damper 87 can be easily and firmly attached to the support member 220 passing through the hole 147 and the hole 147 of the housing 140, and the damper 87 can be prevented from being separated from the housing 140 due to vibration of the housing 140.

The damping force of the damper and/or the settling time of the vibration of the housing may vary based on the relative arrangement positions of the damper and one end of the support member coupled to the upper elastic member. That is, the damping force of the damper for reducing vibration of the housing may vary depending on the height at which the damper is disposed between one end of the support member and the other end of the support member, and this may cause the stabilization time to vary.

In a view of a control perspective for OIS operation, under conditions where a predetermined driving force is supplied, control of the damping force of the damper and the settling time of vibration of the housing may be necessary.

Unlike the comparative example in which the damper is disposed closer to one end of the support member coupled to the upper elastic member, in the embodiment, the damper 87 may be disposed closer to the lower surface of the housing 140 than the upper surface of the housing 140. As shown in FIG. 20, the damper 87 may be disposed close to a center of the support member 220, and under the condition that predetermined driving force for OIS operation is supplied, the damping force of the damper in the embodiment is greater than that of the damper in the comparative example, and the stabilization time for vibration of the housing in the embodiment can be further reduced. That is, in the embodiment, the damping force of the damper 87 can be increased, and the stabilization time during OIS operation can be reduced.

FIG. 21 is a cross-sectional view of the lens driving device 100-1 according to another embodiment.

Referring to FIG. 21, compared to the lens driving device 100, the arrangement of the second coil 230A and the connection of the other end of the support member 220 may be different in the lens driving device 100-1, the description of the lens driving device 100 except the arrangement of the second coil 230A and the connection of the other end of the support member 220 may be applied or analogously applied to the lens driving device 100-1.

In the lens driving device 100-1, the circuit board 250-1 may be disposed on the base 210-1. The second coil 230A may be disposed on the circuit board 250-1 to correspond to, face, or overlap the magnet 130 in the optical axis direction, and may be conductively connected to the circuit board 250-1. For example, the second coil 230A may include a plurality of coil units corresponding to a plurality of magnet units of the magnet 130. For example, the second coil 230A may be formed on a circuit member 231 which is separated from the circuit board 250-1. In another embodiment, the second coil 230A may be in the form of a patterned coil formed on the circuit board 250-1. Alternatively, in another embodiment, the circuit member 231 may be omitted, and the second coil 230A may be implemented in the form of a ring-shaped coil block separately from the circuit board 250. An escape portion may be formed in the circuit member 231 on which the second coil 230A is provided to avoid spatial interference with the support member 220, and the escape portion may be a chamfer shape, a groove, or a through hole. The description of the second coil 230, except the description of the arrangement of the second coil 230, may be applied or analogously applied to the second coil 230A.

The second position sensor 240-1 may be disposed at the circuit board 250-1 and conductively connected to the circuit board 240-1. The description of the second position sensor 240 may be applied or analogously applied to the second position sensor 240-1.

In the lens driving device 100-1, the terminal member 27 may be omitted, and the other end of the support member 220 may be coupled to the circuit board 250-1 by solder 903 or a conductive adhesive, and may be conductively connected to the circuit board 250-1. For example, the other end of the support member 220 may be coupled to the lower surface of the circuit board 250-1 by solder 903. The circuit board 250-1 may include a pad 25-1 that is coupled and conductively connected to the other end of the support member 220 by solder 903. The circuit board 250-1 may include an escape portion, for example, a through hole or a groove, to avoid spatial interference with the support member 220.

Descriptions related to D1 to D4 of FIGS. 18 to 20 may be applied or analogously applied to the embodiment of FIG. 21.

For example, the damper 87 may be disposed closer to the second coil 230A than the upper surface of the housing 140 or the first surface 60A of the housing 140. For example, the seventh separation distance D7 between the damper 87 and the upper surface of the coil 230A is smaller than the second separation distance D2 between the damper 87 and the upper surface (or first surface 60A) of the housing 140 (D7<D2).

For example, the seventh separation distance D7 is a distance in the optical axis direction between an imaginary line (or an extension line) parallel to the upper surface of the second coil 230A (or the upper surface of the circuit member 231) and the lowermost portion of the damper 87. In other embodiments, D7 may be greater than or equal to D2.

For example, the damper 87 may be disposed closer to the second coil 230A than the upper elastic member 150. For example, the seventh separation distance D7 between the damper 87 and the second coil 230A is less than the fourth separation distance in the optical axis direction between the damper 87 and the upper elastic member 150 (e.g., the second coupling portion 92).

For example, a separation distance D8 between the damper 87 and the second circuit board 250-1 is greater than the second separation distance (D2) between the damper 87 and the upper surface (or first surface 60A) of the housing 140 (D8>D2). In other embodiments, D8 may be less than or equal to D2.

For example, the separation distance D5 in the optical axis direction between the damper 87 and one end of the support member 220 may be smaller than a separation distance D9 in the optical axis direction between the damper 87 and the other end of the support member 220 (D5<D9). Here, the other end of the support member 220 may be another portion where the circuit board 250-1 and the support member 220 are coupled by using solder 903. In another embodiment, the separation distance in the optical axis direction between the damper 87 and one end of the support member 220 may be greater than or equal to the separation distance in the optical axis direction between the damper 87 and the other end of the support member 220.

As described above, in the embodiment, two dampers 88 and 87 which are spaced apart from each other are provided to absorb and control the vibration of the housing 140 during OIS operation, and the restraint force (or damping effect) of the damper on the elastic member 150 and the support member 220 may be independently controlled, and thus the vibration of the housing 140 during OIS operation can be precisely controlled. In addition, in the embodiment, the resonance frequency, for example, the first or second resonance frequency by the vibration of the housing 140 during OIS operation can be precisely controlled.

Meanwhile, the lens moving apparatus according to the above-described embodiment may be used in various fields, for example, a camera device or an optical instrument.

In addition, the lens moving apparatus 100 according to the embodiment may be included in an optical instrument for the purpose of forming an image of an object present in a space using reflection, refraction, absorption, interference, and diffraction, which are characteristics of light, for the purpose of increasing visibility, for the purpose of recording and reproduction of an image using a lens, or for the purpose of optical measurement or image propagation or transmission. In an example, the optical instrument according to the embodiment may be a cellular phone, a mobile phone, a smartphone, a portable smart device, a digital camera, a laptop computer, a digital broadcasting terminal, a personal digital assistant (PDA), a portable multimedia player (PMP), a navigation device, etc., without being limited thereto, and may also be any of devices for capturing images or pictures.

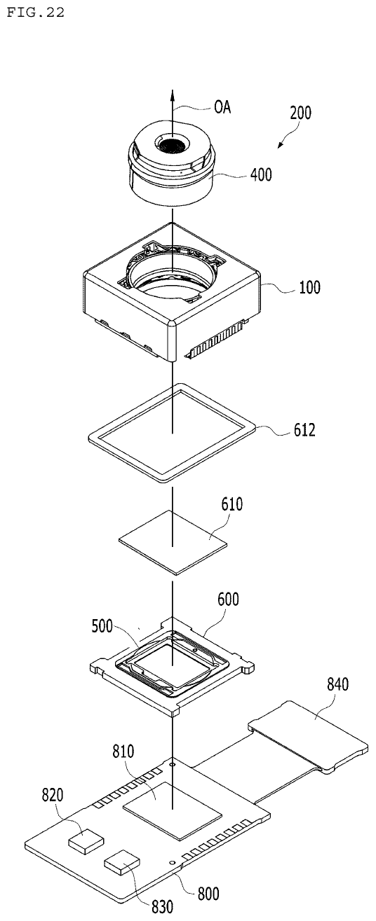

FIG. 22 is an exploded perspective view of a camera device 200 according to an embodiment.

Referring to FIG. 22, the camera device 200 may include a lens barrel 400, and the lens driving device 100.

For example, the camera device 200 may further include a filter 610 and a circuit board 800. In addition, the camera device 200 may further include a holder 600. The camera device 200 may further include a controller 830. The camera device 200 may include at least one of an adhesive member 612, a motion sensor 820, and a connector 840. The camera device 200 may be alternatively expressed as “camera module”, “camera”, or “imaging device”.

The lens barrel 400 may be mounted in or coupled to the bobbin 110 of the lens driving device 100.

The holder 600 may be disposed under the base 210 of the lens driving device 100. The filter 610 may be mounted on the holder 600, and the holder 600 may include a protruding portion 500 on which the filter 610 is seated.

The adhesive member 612 may couple or attach the base 210 of the lens driving device 100 to the holder 600. In addition to the attachment function described above, the adhesive member 612 may serve to prevent foreign substances from entering the lens driving device 100.

The adhesive member 612 may be, for example, epoxy, a thermosetting adhesive, an ultraviolet curable adhesive, or the like.

The filter 610 may serve to prevent light within a specific frequency band, having passed through the lens barrel 400, from being introduced into the image sensor 810. The filter 610 may be an infrared cut filter, but the disclosure is not limited thereto. Here, the filter 610 may be disposed parallel to the X-Y plane.

A bore may be formed at a region of the holder 600 on which the filter 610 is mounted so as to allow the light that has passed through the filter 610 to be introduced into the image sensor 810.

The circuit board 800 may be disposed under the holder 600, and the image sensor 810 may be mounted on the holder 600. The image sensor 810 is a part into which the light that has passed through the filter 610 is introduced so as to form an image contained in the light. The circuit board 800 may include various circuits, elements, and a controller in order to convert the image, formed on the image sensor 810, into electrical signals and to transmit the electrical signals to an external device.

The image sensor 810 is disposed or mounted on the circuit board 800, and a circuit pattern electrically connected to the image sensor 810, various circuits, elements, and/or the controller 830 may be formed at the circuit board 800.

The holder 600 may be referred to as “sensor base”, and the circuit board 800 may be referred to as a “substrate”.

The image sensor 810 may receive an image contained in the light introduced through the lens driving device 100, and may convert the received image into electrical signals. The filter 610 and the image sensor 810 may be disposed to be spaced apart from each other so as to face each other in the first direction.

The motion sensor 820 may be mounted on the circuit board 800, and may be conductively connected to the controller 830 through the circuit pattern formed on the circuit board 800. The motion sensor 820 outputs rotational angular speed information regarding the movement of the camera device 200. The motion sensor 820 may be embodied as two-axis gyro sensor, three-axis gyro sensor or an angular speed sensor.

The controller 830 may be mounted on the circuit board 800, and may be conductively connected to the first position sensor 170, the second position sensor 240 and the second coil 230 of the lens driving device 100. In addition, the controller be conductively connected to the first coil 120 and the second coil 230.

In an example, the circuit board 800 may be conductively connected to the second circuit board 250 of the lens driving device 100, and the controller 830 mounted on the circuit board 800 may be conductively connected to the first position sensor 170 and the second position sensor 240. In addition, the controller 830 may be conductively connected to the first coil and the second coil 230 through the circuit boards 190, 250 and 800.

The controller 830 may provide a driving signal to each of the first position sensor 170, the first sensor 240A, and the second sensor 240A. For example, in another embodiment, the controller 830 may provide a power signal to at least one of the first position sensor 170, the first sensor 240A, and the second sensor 240A, and the controller 830 may transmit a clock signal and a data signal for I2C communication to at least one of the first position sensor 170, the first sensor 240A, and the second sensor 240B or receive the clock signal and a data signal from at least one of the first position sensor 170, the first sensor 240A, and the second sensor 240B.

Additionally, the controller 830 may perform a feedback auto-focusing operation on the AF movable unit of the lens driving device based on the output provided from the first position sensor 170. Additionally, the controller 830 may perform handshake correction operation on the OIS movable unit of the lens driving device 100 based on the output of the first sensor 240A and the output of the second sensor 240B.

The connector 840 may be conductively connected to the circuit board 800, and may have a port for conductive connection to an external device.

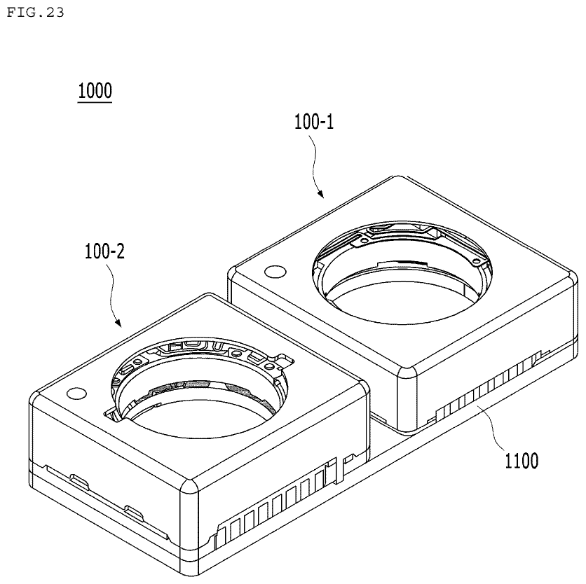

FIG. 23 is a perspective view of a camera device 1000 according to another embodiment.

Referring to FIG. 23, the camera device 1000 may be a dual camera device including a first camera device 100-1 including a first lens driving device and a second camera device 100-2 including a second lens driving device.

For example, each of the first camera device 100-1 and the second camera device 100-2 may be one of an Auto Focus (AF) camera device and an Optical Image Stabilizer (OIS) camera device. The AF camera device is one that can only perform the autofocus function, and the OIS camera device is one that can perform the autofocus function and the OIS (Optical Image Stabilizer) function.

For example, the first lens driving device may be the embodiment 100 shown in FIG. 1, and the second lens driving device may be the embodiment shown in FIG. 1 or an AF lens driving device.

The camera device 1000 may further include a circuit board 1100 for mounting the first camera device 100-1 and the second camera device 100-2. In FIG. 23, the first camera device 100-1 and the second camera device 100-2 are arranged side by side on a single circuit board 1100, but the present invention is not limited to this. In another embodiment, the circuit board 1100 may include a first circuit board and a second circuit board that are separated from each other, and the first camera device 100-1 may be disposed on the first circuit board, and the second camera device may be disposed on the second circuit board.

Additionally, the camera device 1000 may include image sensors for each of the first camera device 100-1 and the second camera device 100-2. The camera device 1000 may include filters for each of the first camera device 100-1 and the second camera device 100-2. The camera device 1000 may include a controller and/or a motion sensor. In this case, the description of the image sensor 810, the filter 610, the controller 830, and the motion sensor 820 may be applied or analogously applied to the camera device 1000 of FIG. 23.

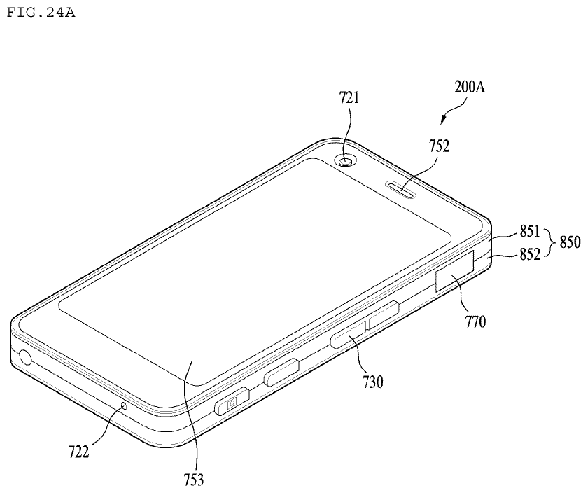

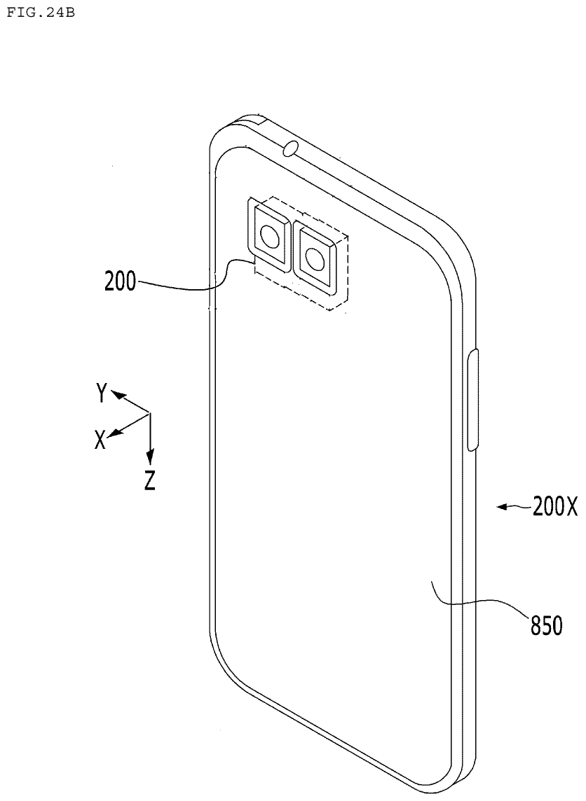

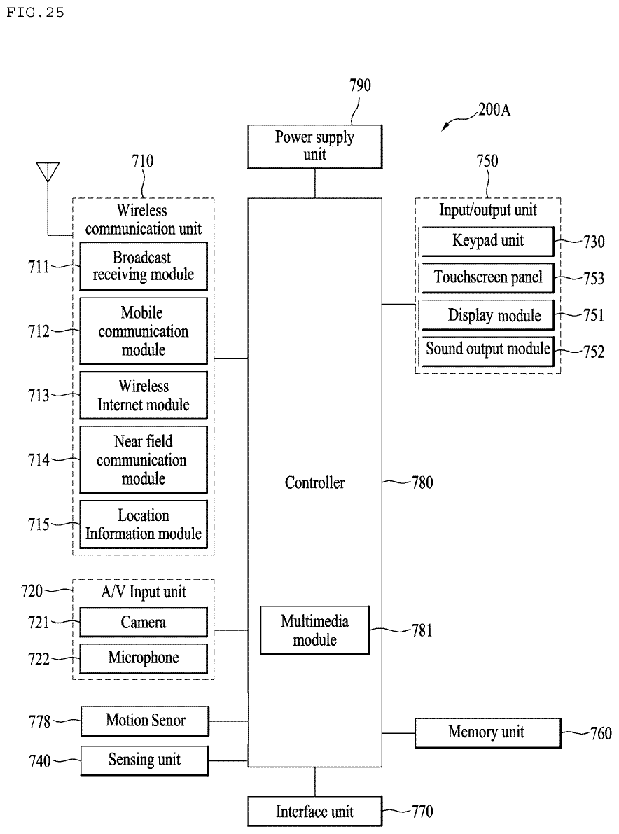

FIG. 24A illustrates a perspective view of the optical device 200A according to an embodiment, FIG. 24B illustrates a perspective view of an optical device 200X according to another embodiment, and FIG. 25 illustrates a configuration diagram of the optical devices 200A and 200X illustrated in FIGS. 24A and 24B.

For example, the embodiment of FIG. 24A may be a front camera of the optical device 200A in which the lens module 400 of the camera device 200 is positioned so as to face the front of the body 850. And the embodiment of FIG. 24B may be a rear camera in which the lens module 400 of the camera device 200 is positioned so as to face the rear of a body 850 of the optical device 200A. FIG. 24B illustrates an example in which two rear cameras are disposed, but in another embodiment, one or more rear cameras may be disposed. In another embodiment, the camera device 200 according to the embodiment may correspond to a front camera and a rear camera of the optical device 200A.

Referring to FIGS. 24a, 24b and 25, the optical device 200A (hereinafter referred to as a “terminal”) may include a body 850, a wireless communication unit 710, an A/V input unit 720, a sensing unit 740, an input/output unit 750, a memory unit 760, an interface unit 770, a controller 780, and a power supply unit 790.

The body 850 shown in FIGS. 24A and 24B has a bar shape, however, the disclosure is not limited thereto. The body may have any of various structures, such as a slide type structure, a folder type structure, a swing type structure, and a swivel type structure, in which two or more sub-bodies are coupled so as to be movable relative to each other.

The body 850 may include a case (casing, housing, cover, etc.) that defines the external appearance thereof. For example, the body 850 may be divided into a front case 851 and a rear case 852. Various electronic parts of the terminal may be mounted in a space defined between the front case 851 and the rear case 852.

The wireless communication unit 710 may include one or more modules that enable wireless communication between the terminal 200A and a wireless communication system or between the terminal 200A and a network in which the terminal 200A is located. For example, the wireless communication unit 710 may include a broadcast receiving module 711, a mobile communication module 712, a wireless Internet module 713, a nearfield communication module 714, and a location information module 715.

The audio/video (A/V) input unit 720, which is configured to input an audio signal or a video signal, may include a camera 721 and a microphone 722.

The camera 721 may be the camera device 200 according to the embodiment

The sensing unit 740 may sense the current state of the terminal 200A, such as the opening and closing state of the terminal 200A, the position of the terminal 200A, whether a user contacts the terminal, the orientation of the terminal 200A, and acceleration/deceleration of the terminal 200A, in order to generate a sensing signal for controlling the operation of the terminal 200A. For example, when the terminal 200A is a slide phone, the sensing unit may sense whether the slide phone is open or closed. In addition, the sensing unit senses whether electric power is supplied from the power supply unit 790 and whether the interface unit 770 is coupled to an external instrument.

The input/output unit 750 is configured to generate input or output related to visual sensation, audible sensation, or tactile sensation. The input/output unit 750 may generate input data for controlling the operation of the terminal 200A, and may display information processed by the terminal 200A.

The input/output unit 750 may include a keypad unit 730, a display module 751, a sound output module 752, and a touchscreen panel 753. The keypad unit 730 may generate input data through keypad input.

The display module 751 may include a plurality of pixels, the color of which is changed according to an electrical signal. For example, the display module 751 may include at least one of a liquid crystal display, a thin film transistor-liquid crystal display, an organic light-emitting diode, a flexible display, and a three-dimensional (3D) display.

The sound output module 752 may output audio data received from the wireless communication unit 710 in a call signal reception mode, a telephone communication mode, a recording mode, a voice recognition mode, or a broadcast reception mode, or may output audio data stored in the memory unit 760.

The touchscreen panel 753 may convert a change in capacitance due to a user's touch on a specific region of the touchscreen into an electrical input signal.

The memory unit 760 may store a program for processing and control of the controller 780, and may temporarily store input/output data (for example, a telephone directory, messages, audio, still images, photographs, and video). For example, the memory unit 760 may store images, such as photographs or video, taken by the camera 721.

The interface unit 770 functions as a path for connection between the terminal 200A and an external instrument. The interface unit 770 may receive data or electric power from the external instrument and transmit the received data or electric power to internal components of the terminal 200A, or may transfer data in the terminal 200A to the external instrument. For example, the interface unit 770 may include a wired/wireless headset port, an external charger port, a wired/wireless data port, a memory card port, a port for connection with an apparatus having an identification module, an audio input/output (I/O) port, a video input/output (I/O) port, and an earphone port.

The controller 780 may control the overall operation of the terminal 200A. For example, the controller 780 may perform related control and processing for voice communication, data communication, and video communication.

The controller 780 may have a multimedia module 781 for multimedia reproduction. The multimedia module 781 may be implemented in the controller 180 or may be implemented separately from the controller 780.

The controller 780 may perform pattern recognition processing that is capable of recognizing writing input or drawing input performed on the touchscreen as text or an image, respectively.

The power supply unit 790 may supply power required to operate the respective components upon receiving external power or internal power under the control of the controller 780.

The features, structures, and effects described in the above embodiments are included in at least one embodiment, but are not limited only to one embodiment. Furthermore, features, structures, and effects illustrated in each embodiment may be combined or modified in other embodiments by those skilled in the art to which the embodiments pertain. Therefore, it is to be understood that such combinations and modifications fall within the scope of the present disclosure.

### INDUSTRIAL APPLICABILITY

Embodiments may be used for a lens driving device, a camera device, and an optical device capable of enabling precise control of the vibration of the housing and maximizing the vibration absorption effect of the housing during OIS operation.

1.-10. (canceled)

11. A lens driving device comprising:
a housing;
a bobbin disposed in the housing and movable in an optical axis direction;
an upper elastic member coupled with an upper portion of the bobbin and an upper portion of the housing;
a circuit board disposed below the housing;
a support member comprising one end coupled to the upper elastic member and the other end electrically connected to the circuit board; and
a first damper coupled to at least a portion of the support member and the housing,
wherein the first damper is spaced apart from the one end of the support member and is disposed closer to a lower surface of the housing than to an upper surface of the housing.

12. The lens driving device according to claim 11, wherein the housing comprises a protruding portion protruding from an outer surface thereof, and the first damper is disposed on the protruding portion.

13. The lens driving device according to claim 11, wherein the protruding portion comprises a hole through which the support member passes, and
wherein the first damper is disposed in the hole.

14. The lens driving device according to claim 11, wherein the housing comprises a recess formed at an upper surface of the protruding portion.

15. The lens driving device according to claim 11, comprising:
a first coil disposed on the bobbin;
a magnet disposed on the housing; and
a second coil disposed under the magnet and configured to move the housing by an interaction with the magnet.

16. The lens driving device according to claim 11, comprising a lower elastic member coupled to a lower portion of the bobbin and a lower portion of the housing,
wherein the first damper is positioned closer to the lower elastic member than the upper elastic member.

17. The lens driving device according to claim 11, comprising a second damper coupled to the upper elastic member and the housing,
wherein the second damper is space apart from the first damper.

18. The lens driving device according to claim 17, wherein the first damper and the second damper do not overlap in the optical axis direction.

19. The lens driving device according to claim 12, wherein the protruding portion of the housing is positioned closer to the lower surface of the housing than the upper surface of the housing.

20. The lens driving device according to claim 11, wherein the housing comprise a side portion and a corner portion, and
wherein the first damper is disposed on the corner portion of the housing.

21. The lens driving device according to claim 17, wherein the upper elastic member comprises a first inner frame coupled with the bobbin, a first outer frame coupled with the housing, and a frame connection portion connecting the first inner frame and the first outer frame, and the second damper is coupled with the first outer frame and spaced apart from the first inner frame and the frame connection portion.

22. A lens driving device comprising:
a housing;
a bobbin disposed in the housing and movable in an optical axis direction;
an upper elastic member coupled to an upper portion of the bobbin and an upper portion of the housing;
a circuit board disposed below the housing;
a support member including one end coupled with the upper elastic member and the other end electrically connected to the circuit board;
a first damper coupled to at least a portion of the support member and the housing; and
a second damper coupled to the upper elastic member and the housing,
wherein the first damper is spaced apart from the one end of the support member, and the second damper is spaced apart from the first damper and spaced apart from the one end of the support member.

23. The lens driving device according to claim 22, wherein the first damper is positioned lower than the second damper.

24. The lens driving device according to claim 23, wherein the first damper overlaps the one end of the support member in the optical axis direction, and the second damper does not overlap the one end of the support member in the optical axis direction.

25. The lens driving device according to claim 22, wherein the upper elastic member comprises a first inner frame coupled with the bobbin, a first outer frame coupled with the housing, and a frame connection portion connecting the first inner frame and the first outer frame,
wherein the first outer frame comprises:
a first coupling portion coupled with the housing;
a second coupling portion coupled with the one end of the support member; and
a connection portion connecting the first coupling portion and the second coupling portion, and
wherein the second damper is coupled with the connection portion.

26. The lens driving device according to claim 25, wherein the second damper is spaced apart from the first inner frame, the frame connection portion, the first coupling portion, and the second coupling portion.

27. The lens driving device according to claim 22, comprising:
a magnet disposed on the housing; and
a second coil configured to move the housing by an interaction with the magnet.

28. A lens driving device comprising:
a housing;
a bobbin disposed in the housing and movable in an optical axis direction;
an upper elastic member coupled to an upper portion of the bobbin and an upper portion of the housing;
a circuit board disposed below the housing;
a supporting member including one end coupled with the upper elastic member and the other end electrically connected to the circuit board; and
a first damper coupled to at least a portion of the support member and the housing,
wherein the housing comprises a protruding portion protruding from an outer side surface thereof, and the first damper is coupled with the protruding portion of the housing and spaced apart from the end of the support member.

29. The lens driving device according to claim 28, wherein a distance between a lower surface of the housing and the protruding portion in the optical axis direction is smaller than a distance between an upper surface of the housing and the protruding portion in the optical axis direction

30. The lens driving device according to claim 28, comprising;
a magnet disposed on the housing; and
a second coil configured to move the housing by an interaction with the magnet.
